(19) United States
(12) Patent Application Publication
(10) Pub. No.: US 2012/0232238 A1
(43) Pub. Date: Sep. 13, 2012

(54) LADDER-TYPE OLIGO-P-PHENYLENE-CONTAINING COPOLYMERS WITH HIGH OPEN-CIRCUIT VOLTAGES AND AMBIENT PHOTOVOLTAIC ACTIVITY

(75) Inventors: Howard Edan Katz, Owings Mills, MD (US); Qingdong Zheng, Fujian (CN); Byung Jun Jung, Baltimore, MD (US)

(73) Assignee: THE JOHNS HOPKINS UNIVERSITY, Baltimore, MD (US)

(21) Appl. No.: 13/388,855

(22) PCT Filed: Aug. 3, 2010
(86) PCT No.: PCT/US2010/044273

§ 371 Date: May 23, 2012

Related U.S. Application Data
(60) Provisional application No. 61/230,851, filed on Aug. 3, 2009.

(51) Int. Cl. C08G 75/06; B82Y 30/00

(52) U.S. Cl. 528/8; 977/734

(57) ABSTRACT

Ladder-type oligo-p-phenylene containing donor-acceptor copolymers are disclosed. The ladder-type oligo-p-phenylene can be used as an electron donor unit in the disclosed copolymers to provide a deeper highest occupied molecular orbital (HOMO) level for obtaining polymeric solar cells having a higher open-circuit voltage. Particular electron-accepting units, e.g., a divalent fused-ring heterocyclic moiety selected from the group consisting of a substituted or unsubstituted benzothiadiazole, a substituted or unsubstituted quinoxaline, a substituted or unsubstituted benzobisthiazole, and a substituted or unsubstituted naphthothiadiazole, can be used to tune the electronic band gaps of the polymers for a better light harvesting ability. The disclosed copolymers exhibit field-effect mobilities as high as 0.011 cm²/(V s). Compared to fluorene-containing copolymers with the same acceptor unit, the disclosed ladder-type oligo-p-phenylene containing copolymers have enhanced and bathochromically shifted absorption bands and much better solubility in organic solvents.

### CROSS-REFERENCE TO RELATED APPLICATIONS

This application claims the benefit of U.S. Provisional Application No. 61/230,851, filed Aug. 3, 2009, which is incorporated herein by reference in its entirety.

### FEDERALLY SPONSORED RESEARCH OR DEVELOPMENT

This invention was made in part with United States Government support under FA9550-06-1-0076 awarded by the Air Force Office of Scientific Research (AFOSR) and DE-FG01-07ER-46465 awarded by the Department of Energy (DOE). The U.S. Government has certain rights in the invention.

### BACKGROUND

In the past decade, there has been increasing interest in polymer solar cells due to the growing demand for “green” and sustainable energy. Compared to today's inorganic solar cells, conjugated polymer-based solar cells are expected to be cheaper because they can be fabricated at a much lower cost with the aid of large area solution casting or roll-to-roll manufacturing of flexible modules. Coakley, K. M.; McGehee, M. D. Chem. Mater. 2004, 16, 4533-4542; Chen, L. M., et al., Adv. Mater. 2009, 21, 1434-1449; Gunes, S., et al., Chem. Rev. 2006, 107, 1324-1338.

Since the introduction of the bulk heterojunction (BHJ) concept, regioregular poly(3-hexylthiophene) (P3HT) has been the standard electron donor material in polymer BHJ solar cells. Sariciftci, N. S., et al., Science 1992, 258, 1474-1476. The highest power conversion efficiency reported for the polymer blend of P3HT and [6,6]-phenyl C₆₁ butyric acid methyl ester (PC₆₁BM, or PCBM) is approximately 5%. Campoy-Quiles, M., et al., Nat. Mater. 2008, 7, 158-164; Li, G., et al., Adv. Funct. Mater. 2007, 17, 1636-1644; Li, G., et al., Nat. Mater. 2005, 4, 864-868; Wang, W., et al., Appl. Phys. Lett. 2007, 90 (18), 183512/1-183512/3; Ma, W., et al., Adv. Funct. Mater. 2005, 15, 1617-1622; Woo, C. H., et al., J. Am. Chem. Soc. 2008, 130, 16324-16329.

The power conversion efficiency and fill factor of a solar cell device are calculated according to the following equations:

η=(FF×J_{sc}×V_{oc})/Pᵢₙ (eq. 1)

FF=(Jₘₐₓ×Vₘₐₓ)/(J_{sc}×V_{oc}) (eq. 2)

where Pᵢₙ is the input power; J_{sc} and V_{oc} are the short-circuit current and open-circuit voltage, respectively; Jₘₐₓ and Vₘₐₓ are the current density and voltage at the maximum power output; and FF is the fill factor. An investigation of the solar cell devices based on the P3HT:PCBM system reveals that its efficiency is limited by low open-circuit voltage V_{oc} (˜0.6 V) and the relatively large band gap of P3HT, which limits its harvesting ability (low J_{sc}). Therefore, in recent years, many low band gap polymers have been developed to increase the light absorbing ability of solar cell devices, because the light absorbing ability is directly related to the value of short-circuit current, J_{sc}. Hou, J., et al., J. Am. Chem. Soc. 2008, 130, 16144-16145; Liang, Y. Y., et al., J. Am. Chem. Soc. 2009, 131, 56-57; Baek, N. S., et al., Chem. Mater. 2008, 20, 5734-5736; Chen, C.-P., et al., J. Am. Chem. Soc. 2008, 130, 12828-12833; Lee, J. K., et al., J. Am. Chem. Soc. 2008, 130, 3619-3623; Lee, J.-Y., et al., J. Mater. Chem. 2009, 19, 4938-4945; Moule, A. J., et al., Chem. Mater. 2008, 20, 4045-4050; Muhlbacher, D., et al., Adv. Mater. 2006, 18, 2884-2889; Zhang, F. L., et al., Adv. Mater. 2006, 18, 2169-2173; Zhang, F. L., et al., Adv. Funct. Mater. 2005, 15, 745-750; Mondal, R., et al., Chem. Mater. 2009, 21, 3618-3628.

The open-circuit voltages for most of these low band gap polymer-based solar cells, however, are in the range of about 0.35 V to about 0.80 V. See Hou, J., et al., J. Am. Chem. Soc. 2008, 130, 16144-16145; Liang, Y. Y., et al., J. Am. Chem. Soc. 2009, 131, 56-57; Baek, N. S., et al., Chem. Mater. 2008, 20, 5734-5736; Lee, J. K., et al., J. Am. Chem. Soc. 2008, 130, 3619-3623; Muhlbacher, D., et al., Adv. Mater. 2006, 18, 2884-2889; Mondal, R., et al., Chem. Mater. 2009, 21, 3618-3628. It has been reported that there is a correlation between V_{oc} and the difference between the highest occupied molecular orbital (HOMO) of the donor and the lowest unoccupied molecular orbital (LUMO) of the acceptor used in bulk heterojunction (BHJ) solar cells. Therefore, reduction of the band gap of a donor polymer also will reduce the open-circuit voltage, because of a decreased energy difference between the HOMO of a polymer and the LUMO of an acceptor (e.g., PC₆₁BM).

To achieve a polymer solar cell device with a high light harvesting ability (low band gap), as well as a high open-circuit voltage, one approach is to design alternating donor-acceptor copolymers, where the electron donor unit may provide a deeper HOMO level and the electron acceptor unit can be used to tune the electronic band gap of the polymers. Recently, this type of donor-acceptor polymer has been used for high-performance solar cells by choosing fluorene or carbazole as the electron donor and benzothiadiazole, quinoxaline, or thienopyrazine as the electron acceptor. Svensson, M., et al., Adv. Mater. 2003, 15, 988-991; Zhou, Q., et al., Appl. Phys. Lett. 2004, 84, 1653-1655; Zhang, F. L., et al., Adv. Funct. Mater. 2006, 16, 667-674; Gadisa, A., et al., Thin Solid Films 2007, 515, 3126-3131; Gedefaw, D., et al., J. Mater. Chem. 2009, 19, 5359-5363; Slooff, L. H., et al., Appl. Phys. Lett. 2007, 90, 143506/1-143506/3; Veldman, D., et al., J. Am. Chem. Soc. 2008, 130, 7721-7735; Blouin, N., et al., J. Am. Chem. Soc. 2007, 130, 732-742; Blouin, N., et al., Adv. Mater. 2007, 19, 2295-2300; Wen, S., et al, Macromolecules 2009, 42 (14), 4977-4984; Park, S. H., et al., Nat. Photonics 2009, 3, 297-302; Lindgren, L. J., et al., Chem. Mater. 2009, 21, 3491-3502; Kitazawa, D., et al., Appl. Phys. Lett. 2009, 95 (5), 053701/1-053701/3. Further, ladder-type oligo-p-phenylenes comprising several “linearly overlapping” fluorenes have been chosen as a building block for materials with various applications. Setayesh, S., et al., Macromolecules 2000, 33, 2016-2020; Sonar, P., et al., Macromolecules 2004, 37, 709-715; Zheng, Q., et al., Adv. Funct. Mater. 2008, 18, 2770-2779; Usta, H., et al., J. Am. Chem. Soc. 2009, 131, 5586-5608; Zhang, W., et al., J. Am. Chem. Soc. 2009, 131, 10814-10815; Yen, W.-C., et al., J. Polym. Sci., Part A: Polym. Chem. 2009, 47, 5044-5056.

### SUMMARY

In one aspect, the presently disclosed subject matter provides a ladder-type oligo-p-phenylene-containing copolymer of Formula (I):

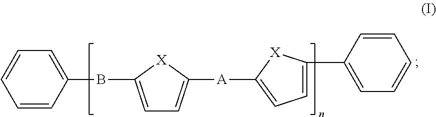

wherein n is an integer from 1 to 1,000; X is selected from the group consisting of S, O, and NR₆, wherein R₆ is selected from the group consisting of hydrogen and C₁-C₄ unsubstituted or substituted, linear or branched alkyl; A comprises an electron-accepting fused ring system; and B comprises a linearly overlapping fluorene system comprising from 2 to 9 fluorene groups, wherein each fluorene group can be independently substituted with one or more linear or branched, substituted or unsubstituted C₄-C₃₀ alkyl chains. In particular aspects, the linearly overlapping fluorene system comprises between 2 and 4 fluorene groups and the electron-accepting fused ring system comprises a divalent fused-ring heterocyclic moiety selected from the group consisting of a substituted or unsubstituted benzothiadiazole, a substituted or unsubstituted quinoxaline, a substituted or unsubstituted benzobisthiazole, and a substituted or unsubstituted naphthothiadiazole.

The presently disclosed ladder-type oligo-p-phenylene-containing copolymers of Formula (I) exhibit high open-circuit voltages and ambient photovoltaic activity. Accordingly, the presently disclosed copolymers of Formula (I) are useful in a variety of photovoltaic applications. In representative aspects, the presently disclosed ladder-type oligo-p-phenylene-containing copolymers of Formula (I) can be included in a field effect transistor (FET), a polymer solar cell, an electroluminescent device, such as an organic light emitting diode, an electrostatic dissipation coating or packaging materials, a chemical sensor, or as a component of a block copolymer.

Certain aspects of the presently disclosed subject matter having been stated hereinabove, which are addressed in whole or in part by the presently disclosed subject matter, other aspects will become evident as the description proceeds when taken in connection with the accompanying Examples and Drawings as best described herein below.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a cross-sectional view of a schematic diagram of a representative electronic device comprising a presently disclosed compound of Formula (I);

FIG. 2 is a cross-sectional view of a schematic diagram of a representative polymer solar cell comprising a presently disclosed compound of Formula (I);

FIGS. 3A-3F are cross-sectional views of schematic diagrams of representative embodiments of field-effect transistors comprising the presently disclosed compounds of Formula (I);

FIGS. 4A-4D are cross-sectional views of schematic diagrams of representative embodiments of electroluminescent devices comprising the presently disclosed compounds of Formula (I);

FIG. 5 is a scheme illustrating the synthesis of the presently disclosed ladder-type oligo-p-phenylene containing copolymers;

FIG. 6 illustrates the synthesis of comonomers 1a-b and 2;

FIGS. 7a-7c show the optical absorption spectra of representative presently disclosed ladder-type oligo-p-phenylene containing copolymers in (a) chlorobenzene solutions; (b) pure polymer films; and (c) polymer:fullerene blends;

FIGS. 8a and 8b are emission spectra of presently disclosed PIFTBT10, PIFDTQ10, PIFTBT6, and P3FTBT6 copolymers in (a) chlorobenzene solutions and (b) thin films;

FIG. 9 illustrates a cyclic voltammogram (CV) of the presently disclosed ladder-type oligo-p-phenylene containing copolymers;

FIGS. 10a and 10b illustrate a DFT-calculated LUMO and HOMO of the geometry optimized structures of analogous monomers of (a) PIFTBT6, PIFTBT10 and (b) P3FTBT6;

FIGS. 11a-11d show I_{d}-V_{d} curves of FET devices comprising the presently disclosed copolymers as a function of V_{g} (left), I_{d-sat}, and I_{d-sat}^{1/2} vs V_{g} (right) based on spin-cast films for the polymers (a) PIFTBT10; (b) PIFDTQ10; (c) PIFTBT6; and (d) P3FTBT6;

FIGS. 12a-12d are AFM topography images (5 μm×5 μm) of films cast from chlorobenzene solutions with (a) PIFTBT10; (b) PIFDTQ10; (c) PIFTBT6; and (d) P3FTBT6. RA: roughness average;

FIGS. 13a and 13b illustrate (a) current density-voltage (J-V) characteristics of photovoltaic (PV) devices based on PIFTBT10 (or PIFTBT6, P3FTBT6):PC₆₁BM polymer blends under simulated solar light (AM 1.5 G, 100 mW/cm², RT, ambient) and (b) current density-voltage (J-V) characteristics of PV devices based on PIFDTQ10(P3FTBT6):PC₇₁BM(PC₆₁BM) polymer blends under simulated solar light (AM 1.5 G, 100 mW/cm², RT, ambient), wherein inset is a representative schematic device structure for a polymer/fullerene bulk heterojunction solar cell;

FIG. 14 illustrates external quantum efficiencies of photovoltaic cells calculated from the photocurrents under short-circuit conditions based on P3FTBT6:PC₆₁BM (blue) and P3FTBT6:PC₇₁BM (red);

FIGS. 15a-15c are atomic force microscopy (AFM) topography images of PIFTBT10:PC₆₁BM (a), PIFDTQ10:PC₆₁BM (b), and PIFTBT6:PC₆₁BM (c) films spin-cast from a mixture of chlorobenzene and o-dichlorobenzene (left) and surface phase images of the films (right); and

FIG. 16 illustrates AFM topography images of P3FTBT6:PC₆₁BM films with two different blend ratios and P3FTBT6:PC₇₁BM films spin-cast from a mixture of chlorobenzene and o-dichlorobenzene (left) and surface phase images of the films (right).

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The presently disclosed subject matter discloses ladder-type oligo-p-phenylenes as electron donor building blocks and electron-accepting fused ring structures, including, but not limited to, 4,7-dithien-2-yl-2,1,3-benzothiadiazole or 5,8-dithien-2-yl-2,3-diphenylquinoxaline, as an electron acceptor building block to obtain copolymers having deeper HOMO energy levels, broader spectral absorption ranges, and improved phase separation properties with PCBMs. The extended π-conjugation of ladder-type oligo-p-phenylene derivatives may lead to a broader, more intense absorption band compared to fluorene derivatives and, thus, result in an enhanced solar light harvesting.

For every repeat unit in the ladder-type oligo-p-phenylene containing polymers, there can be, in some embodiments, at least four alkyl chains on the polymer backbone. Soluble alkyl chains can be introduced into this unique molecular backbone, which may provide a better solution processability of the target polymers. The presently disclosed subject matter further demonstrates that, among polymers for photovoltaic (PV) applications, substituting the ladder-type oligo-p-phenylene moieties with one or more alkyl groups, such as a hexyl group, provides a good balance between crystallinity and miscibility in the bid to achieve optimal morphology. On the other hand, polymers with decyl substituent groups have better solubility compared to those with hexyl groups, and the decyl group has been reported to be a good side chain for fluorene-containing polymers to achieve high power conversion efficiency. Nguyen, L. H., et al., Adv. Funct. Mater. 2007, 17, 1071-1078; Veldman, D., et al., J. Am. Chem. Soc. 2008, 130, 7721-7735. Accordingly, in particular embodiments of the presently disclosed subject matter, both hexyl and decyl are chosen as side chains for targeted soluble copolymers. More particularly, the presently disclosed subject matter provides the synthesis, characterization, photophysical properties, field effect transistors behaviors, and photovoltaic properties of the presently disclosed ladder-type oligo-p-phenylene containing copolymers.

### I. LADDER-TYPE OLIGO-P-PHENYLENE-CONTAINING COPOLYMERS WITH HIGH OPEN-CIRCUIT VOLTAGES AND AMBIENT PHOTOVOLTAIC ACTIVITY

A. Oligo-p-Phenylene-Containing Copolymers

In some embodiments, the presently disclosed subject matter provides a ladder-type oligo-p-phenylene-containing copolymer of Formula (I):

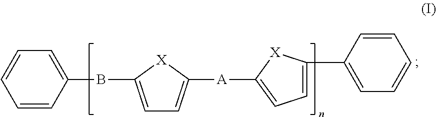

wherein n is an integer from 1 to 1,000; X is selected from the group consisting of S, O, and NR₆, wherein R₆ is selected from the group consisting of hydrogen and C₁-C₄ unsubstituted or substituted, linear or branched alkyl; A comprises an electron-accepting fused ring system; and B comprises a linearly overlapping fluorene system comprising from 2 to 9 fluorene groups.

The term “linearly overlapping fluorene system comprising from 2 to 9 fluorene groups” includes divalent radicals having a chemical structure selected from the group consisting of:

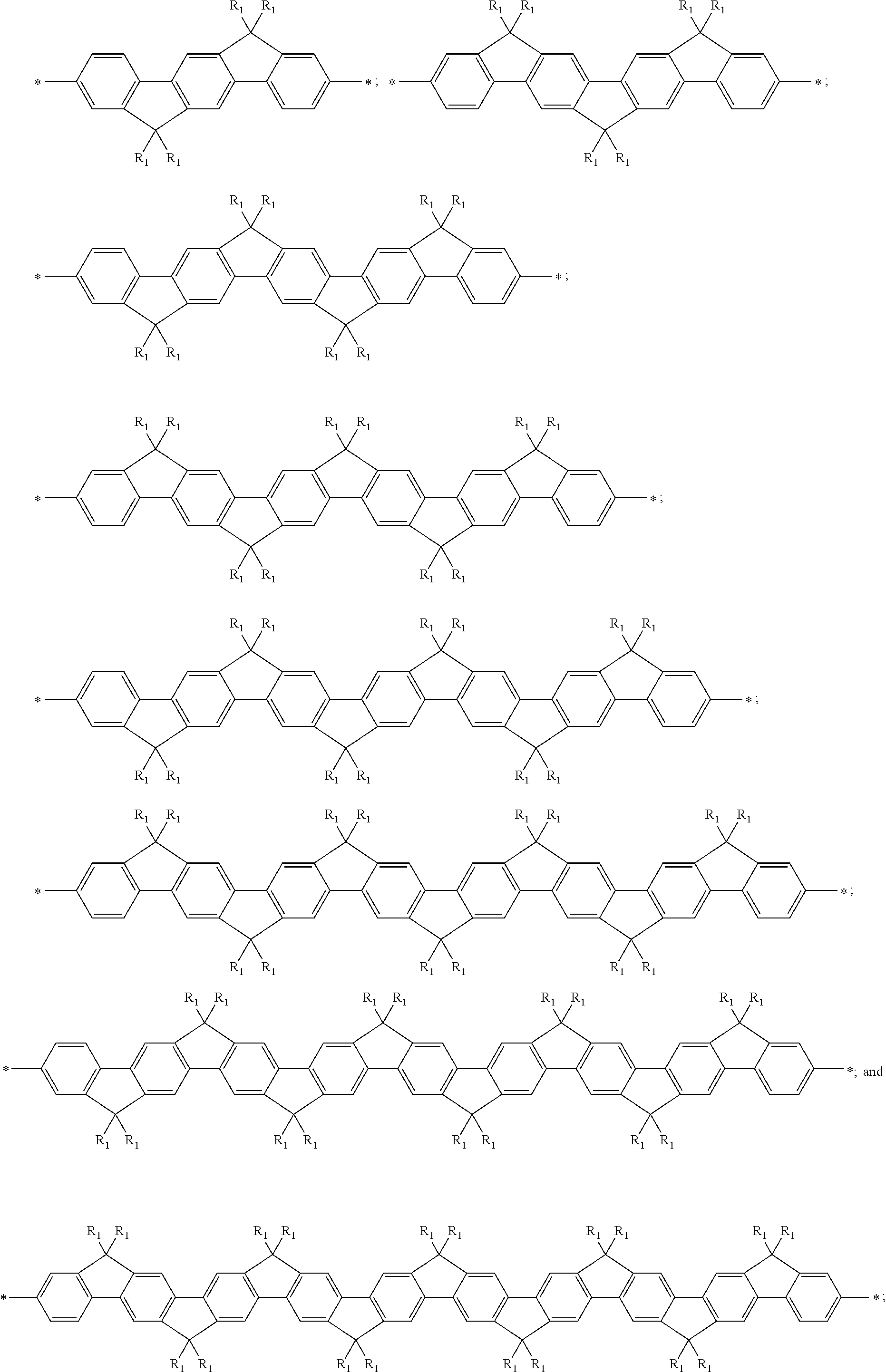

wherein each R₁ independently comprises a linear or branched, substituted or unsubstituted C₄-C₃₀ alkyl chain, wherein one or more oxygen, sulfur, or nitrogen atoms can be substituted for a carbon atom in the alkyl chain; and the symbol (*) indicates the points of attachment of the divalent linearly overlapping fluorene system to the remainder of the compound of Formula (I).

In some embodiments, the electron-accepting fused ring system comprises a divalent fused-ring heterocyclic moiety selected from the group consisting of a substituted or unsubstituted benzothiadiazole, a substituted or unsubstituted quinoxaline, a substituted or unsubstituted benzobisthiazole, and a substituted or unsubstituted naphthothiadiazole. In representative, non-limiting embodiments, the electron-accepting fused ring system comprises a divalent radical comprising a fused ring structure selected from the group consisting of 2,1,3-benzothiadiazole; 2,3-diphenylquinoxaline; benzo[1,2-c; 4,5-c′]bis[1,2,5]thiadiazole; and naphtho[2,3-c][1,2,5]thiadiazole.

One of ordinary skill in the art upon review of the presently disclosed subject matter would recognize that many electron-accepting moieties would be suitable for use with the presently disclosed copolymers of Formula (I). Typical electron acceptors suitable for use, for example, in polymer solar cells include, but are not limited to, (poly[2-methoxy-5-(2′-ethylhexyloxy)]-1,4-(1-cyanovinylene)-phenylene) (CN-MEHPPV); (poly(9,9′-dioctylfluorene-co-benzothiadiazole)) (F8BT), thienopyrazines, and a soluble derivative of C60, referred to as PCBM ([6,6]-phenyl C61-butyric acid methyl ester). Preferred characteristics of suitable electron-acceptors include solution-processability due to side-chain solubilization, a strong photo- and electroluminescence, and chemical, photochemical, and thermal stability.

Further, substitution of a fused ring system with electron-withdrawing functional groups can impart an electron-accepting characteristic to a particular fused ring system. Such electron-withdrawing functional groups include, but are not limited to, —C≡N, —CF₃, —F, —C═O, and diimides. Such groups act as electron withdrawing groups, particularly if they are a part of a conjugated system.

The presently disclosed copolymers of Formula (I) optionally can be blended with an additional chemical component, which in representative embodiments, includes a fullerene, such as C₆₀, C₇₀, or C₈₀ and higher fullerenes, or a substituted fullerene compound, such as PCBM ([6,6]-phenyl C₆₁ butyric acid methyl ester), PCBB ([6,6]-phenyl C₆, butyric acid butyl ester), and analogs or derivatives thereof. One of ordinary skill in the art would recognize upon review of the presently disclosed subject matter that fullerenes substituted with a variety of organic moieties would be suitable for use with the presently disclosed copolymers of Formula (I), e.g., the methyl group of PCBM could be replaced by a variety of organic moieties known in the art.

In certain embodiments, the compound of Formula (I) has a chemical structure selected from the group consisting of:

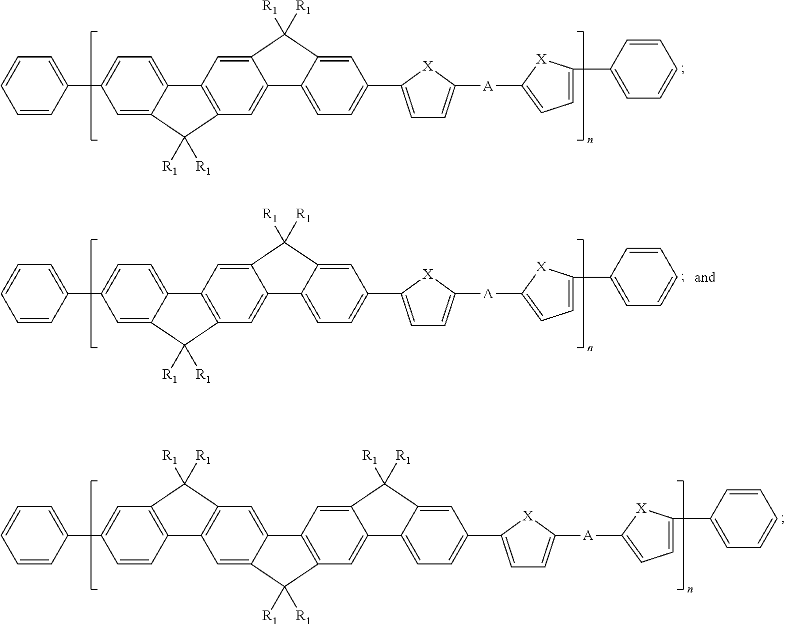

wherein n is an integer from 1 to 1000; X is selected from the group consisting of S, O, and NR₆, wherein R₆ is selected from the group consisting of hydrogen and C₁-C₄ unsubstituted or substituted, linear or branched alkyl; A comprises an electron-accepting fused ring system; and each R₁ independently comprises a linear or branched, substituted or unsubstituted C₄-C₃₀ alkyl chain, wherein one or more oxygen, sulfur, or nitrogen atoms can be substituted for a carbon atom in the alkyl chain.

In yet other embodiments, the compound of Formula (I) has a chemical structure selected from the group consisting of:

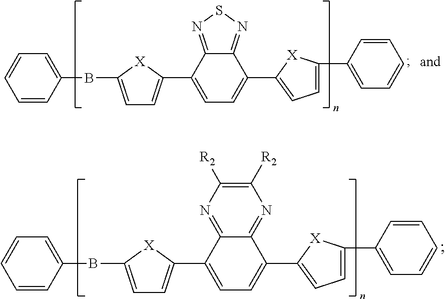

wherein n is an integer from 1 to 1,000; X is selected from the group consisting of S, O, and NR₆, wherein R₆ is selected from the group consisting of hydrogen and C₁-C₄ unsubstituted or substituted, linear or branched alkyl; B comprises a linearly overlapping fluorene system comprising from 2 to 9 fluorene groups; and each R₂ is independently selected from the group consisting of hydrogen, hydroxyl, amino, alkoxyl, halogen, substituted or unsubstituted alkyl, substituted or unsubstituted heteroalkyl, perfluoroalkyl, substituted or unsubstituted cycloalkyl, substituted or unsubstituted heterocycloalkyl, substituted or unsubstituted aryl, substituted or unsubstituted arylalkyl, substituted or unsubstituted heteroaryl, and substituted or unsubstituted heteroarylalkyl. In certain embodiments, R₂ is phenyl.

In particular embodiments, the compound of Formula (I) has a chemical structure selected from the group consisting of:

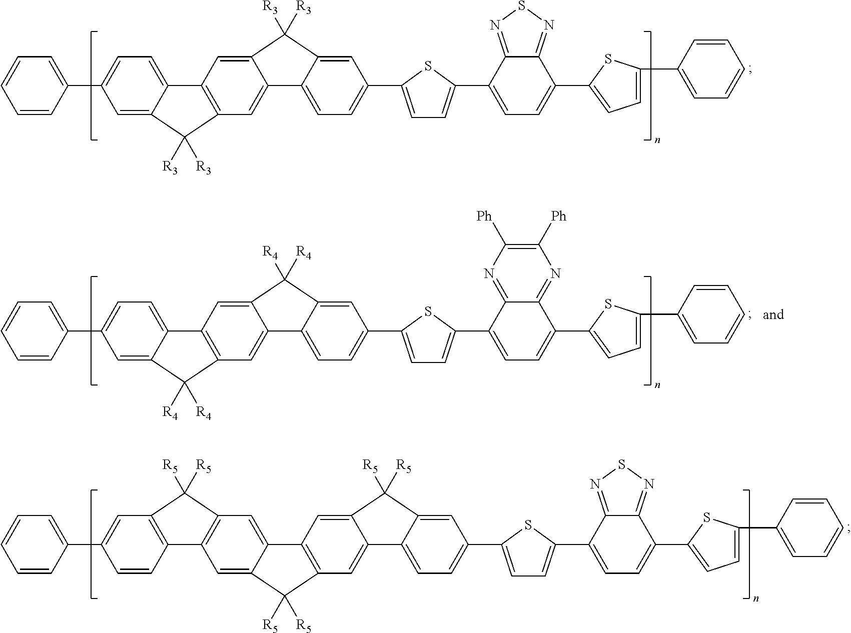

wherein n is an integer from 1 to 1000; Ph is phenyl; R₃ is selected from the group consisting of n-C₆H₁₃ (PIFTBT6) and n-C₁₀H₂₁ (PIFTBT10); R₄ is n-C₁₀Hₙ (PIFDTQ10); and R₅ is n-C₆H₁₃ (P3FTBT6).

As described in more detail herein below, the presently disclosed ladder-type oligo-p-phenylene-containing copolymer of Formula (I) exhibit high open-circuit voltages and ambient photovoltaic activity. Accordingly, the presently copolymers can be used in field effect transistors (FETs), such as a top-contact bottom-gate transistor, in a polymer solar cell, which can comprise or more layers of additional materials, an electroluminescent device, such as an organic light emitting diode, a chemical sensor, and can make up at least one component of a block copolymer.

B. Representative Photovoltaic and Opto-Electronic Devices and Other Materials Comprising Oligo-p-Phenylene Copolymers of Formula (I)

Electronic devices based on organic materials (e.g., small organic molecules and organic polymers) have attracted broad interest. Such devices include organic light emitting devices (OLEDs) (Tang, C. W.; VanSlyke, S. A.; Appl. Phys. Lett. 1987, 51, 913), organic photovoltaic cells (OPVs) (Tang, C. W. Appl. Phys. Lett. 1986, 48, 183), transistors (Bao, Z.; Lovinger, A. J.; Dodabalapur, A. Appl. Phys. Lett. 1996, 69, 3066), bistable devices and memory devices (Ma, L. P.; Liu, J.; Yang, Y. Appl. Phys. Lett. 2002, 80, 2997), and the like.

Generally, the presently disclosed copolymers of Formula (I) are useful in any application wherein a conjugated polymer, particularly a conjugated photovoltaic polymer, would have utility. For example, the presently disclosed copolymers of Formula (I) can be suitable as the active materials in the following devices: thin film semiconductor devices, such as polymer solar cells, organic light emitting diodes, transistors, photodetectors, and photoconductors; electrochemical devices such as rechargeable batteries, capacitors, supercapacitors, and electrochromic devices, and sensors.

In most embodiments of electronic devices comprising organic materials, a solution process is highly desirable. Because the presently disclosed copolymers of Formula (I) are soluble in common organic solvents, conventional methods known in the art can be used to cast polymeric materials comprising copolymers of Formula (I) to provide solid forms of the compositions, including, but not limited to, thin films forms and printed forms. Accordingly, compositions comprising the copolymers of Formula (I) can be dissolved or dispersed in a suitable solvent(s) and then coated onto a substrate and allowed to dry. Solid films of the copolymers of Formula (I) can be formed that comprise a residual amount of solvent, are substantially free of solvent, or are free of solvent. For example, the amount of solvent remaining in the solid film, in some embodiments, can be less than about 5% by weight, in some embodiments, less than about 1% by weight, or, in some embodiments, less than about 0.1% by weight. Suitable coating methods include, but are not limited to, roll coating, screen printing, spin casting, spin coating, doctor blading, dip coating, spray coating, and ink jet printing, as well as other coating and printing methods known in the art.

Depending on the characteristics desired for any one particular application, the thickness of the film coated onto a substrate can be, for example, in some embodiments, about 10 nm to about 500 μm, in some embodiments, about 50 nm to about 250 nm, or, in some embodiments, about 100 nm to about 200 nm.

Optionally, the resulting films can be thermally annealed. Annealing is preferably carried out in an inert (e.g., Ar or N₂) atmosphere. The annealing temperature and time can be adjusted to achieve a desired result. For example, in some embodiments, the annealing temperature can range from about 50° C. to about 200° C., or, in some embodiments, from about 130° C. to about 180° C. In particular embodiments, the annealing temperature can be below the melting temperature of the copolymer of Formula (I). In other embodiments, the annealing temperature can be below, at, or above the glass transition temperature of the copolymer of Formula (I). In particular embodiments, the annealing temperature can be from about 5° C. to about 60° C. above the glass transition temperature.

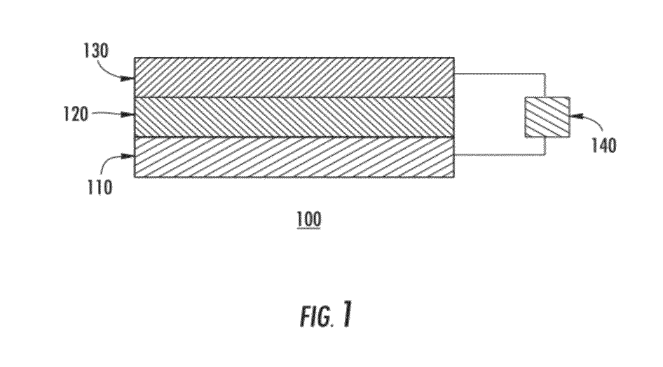

Referring now to FIG. 1, a cross-sectional view of a generic electronic or electro-optic device comprising a compound of Formula (I) is provided. Generally, device 100 comprises a substrate 110, a first electrode 120, layer 130 comprising an electroactive compound of Formula (I), a second electrode 140, wherein layer 130 comprises a first surface in operational contact with the first electrode and a second surface in operational contact with the second electrode. Device 100 optionally can comprise external load 150. Accordingly, the presently disclosed subject matter provides, in representative embodiments, an electronic or electro-optic device comprising: (a) a first electrode, e.g., an anode; (b) a second electrode, e.g., a cathode; and (c) a layer of electroactive material operationally disposed between the first and the second electrode, wherein the electroactive layer comprises a compound of Formula (I).

i. Polymer Solar Cells

A conductive polymer solar cell can be fabricated to incorporate the presently disclosed ladder-type oligo-p-phenylene-containing copolymer of Formula (I) in a variety of solar cell architectures known in the art. Generally, a conventional solar cell configuration that can be used with the presently disclosed copolymers of Formula (I) includes structures for carrying out one or more of the following steps: (i) light absorption, i.e. absorption of photons; (ii) exciton creation and diffusion, where “excitons” are a mobile neutral combination of an electron in an excited state and a hole; (iii) charge separation; (iv) charge transport; and (v) charge collection.

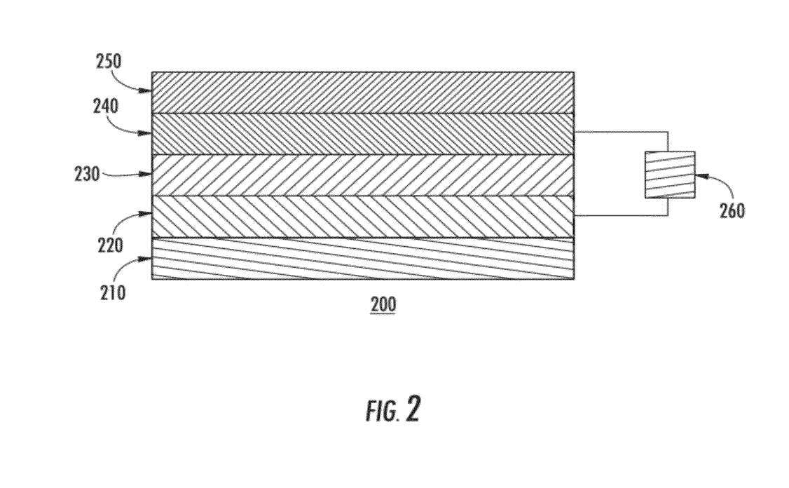

Referring now to FIG. 2, a cross-sectional view of a schematic diagram of a representative polymer solar cell comprising a compound of Formula (I) is provided. In representative embodiments, polymer solar cell 200 includes substrate 210. In some embodiments, substrate 210 comprises a transparent inorganic substrate, such as quartz and glass, or a transparent plastic substrate selected from the group consisting of polyethylene terephthalate (“PET”), polyethylene naphthalate (“PEN”), polycarbonate (“PC”), polystyrene (“PS”), polypropylene (“PP”), polyimide (“PI”), polyethersulfonate (“PES”), polyoxymethylene (“POM”), acrylonitrile/styrene (“AS”) resin, acrylonitrile/butadiene/styrene (“ABS”) resin and a combination comprising at least one of the foregoing.

Substrate 210 is coated with conductive material 220, which forms a first electrode, or anode. Representative examples of suitable materials comprising conductive material 220 include, but are not limited to, indium tin oxide (“ITO”), gold, silver, fluorine-doped tin oxide (“FTO”), ZnO—Ga₂O₃, ZnO—Al₂O₃, and SnO₂—Sb₂O₃. In particular embodiments, conductive material 220 is indium tin oxide (ITO).

Polymer cell 200 also can include a layer, e.g., a hole injection layer, comprising conductive polymer 230, which, in some embodiments, can enhance the performance of polymer cell 200. Examples of suitable conductive polymers include one or more conductive polymers selected from the group consisting of “PEDOT” (poly(3,4-ethylenedioxythiophene), “PSS” (poly(styrenesulfonate)), polyaniline, phthalocyanine, pentacene, polydiphenylacetylene, poly(t-butyl)diphenylacetylene, poly(trifluoromethyl)diphenylacetylene, Cu-PC (copper phthalocyanine), poly(bistrifluoromethyl)acetylene, polybis(t-butyldiphenyl)acetylene, poly(trimethylsilyl)diphenylacetylene, poly(carbazole)diphenylacetylene, polydiacetylene, polyphenylacetylene, polypyridine acetylene, polymethoxyphenylacetylene, polymethylphenylacetylene, poly(t-butyl)phenylacetylene, polynitrophenylacetylene, poly(trifluoromethyl)phenylacetylene, poly(trimethylsilyl)phenylacetylene, and derivatives thereof, and a combination comprising at least one of the foregoing polymers. In particular embodiments, conductive polymer 230 comprises a mixture of PEDOT-PSS.

More particularly, solar cell 200 can comprise photoactive layer 240 comprising a copolymer of Formula (I). As provided hereinabove, photoactive layer 240 can comprise a pure copolymer of Formula (I) or a blend of a copolymer of Formula (I) and a fullerene, such as C₆₀, C₇₀, or C₈₀ and higher fullurenes, or a substituted fullerene compound, such as PCBM ([6,6]-phenyl C₆₁ butyric acid methyl ester), PCBB ([6,6]-phenyl C₆, butyric acid butyl ester), and analogs or derivatives thereof. In representative embodiments, photoactive layer 240 can have a thickness ranging from about 5 nm to about 2000 nm. Photoactive layer 240 can be applied on conductive polymer 230 using any coating process known in the art, for example, spraying, spin coating, dipping, printing, doctor blading, or sputtering, or through electrodeposition.

Solar cell 200 further comprises second electrode 250, e.g., a cathode, which typically comprises a material having a low work function. Suitable examples of such material include, but are not limited to, metals, such as magnesium, calcium, sodium, potassium, titanium, indium, yttrium, lithium, aluminum, silver, tin, lead, or the like, or a combination comprising at least one of the foregoing metals. Second electrode 250 can further comprise a multilayer structure obtained by forming a LiF, LiO₂, or Cs₂O₃ buffer layer on the electron-accepting layer and then depositing the above electrode material, e.g., Al, on the buffer layer. Device 200 optionally can comprise external load 260.

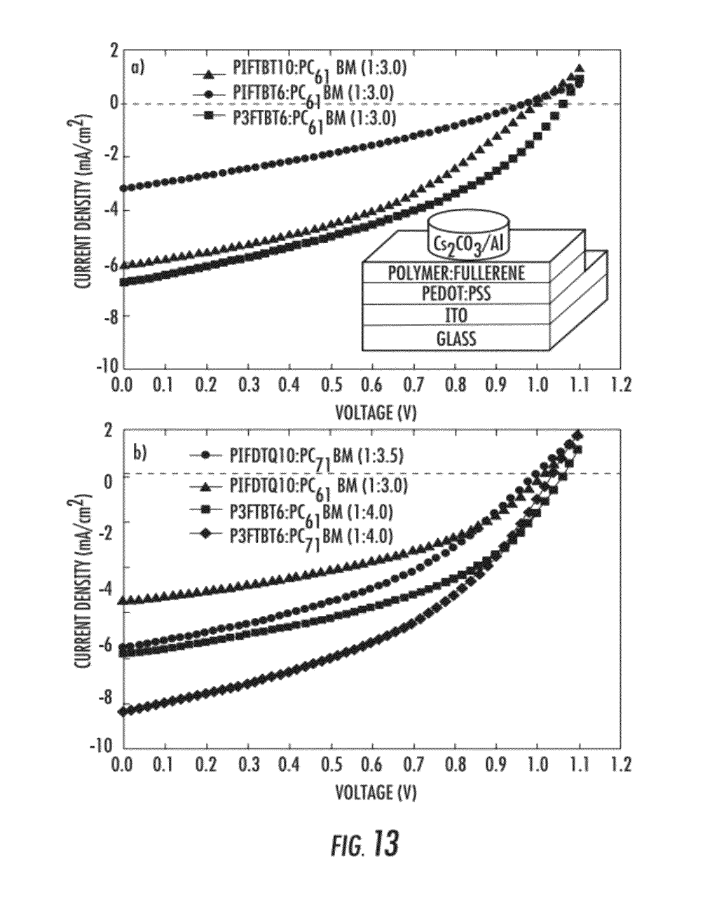

For a representative embodiment of a polymer solar cell comprising a copolymer of Formula (I) or a blend thereof, e.g., a blend with a fullerene, see FIG. 13 (insert). In this embodiment, because the ITO substrate is transparent, the solar cell is illuminated from this side of the device. The two electrodes can be further modified by introducing a PEDOT:PSS (poly[3,4-(ethylenedioxy)thiophene]:poly(styrene sulfonate) coating between the photoactive layer and an ITO-coated substrate (anode) and a lithium fluoride (LiF) underlayer on a aluminum electrode (cathode).

As provided in more detail herein below, the properties of an organic solar cell can be measured by various parameters, including the fill factor, FF, the current density at short circuit, J_{sc}, the photovoltage at open circuit, V_{oc}, and the power conversion efficiency.

ii. Field Effect Transistors

In some embodiments, a field-effect transistor, which, in particular embodiments, can be a thin film transistor, can comprise or incorporate a compound of Formula (I). In particular embodiments, the field-effect transistor is a top-contact bottom-gate transistor. A typical thin film transistor includes a substrate; a source electrode and a drain electrode disposed over the substrate; a semiconductor layer, including, for example, the presently disclosed copolymers of Formula (I), disposed over the source and drain electrodes and the substrate; an insulating layer disposed over the semiconductor layer; and a gate electrode disposed over the insulating layer. This description is intended only to illustrate one embodiment of a typical thin-film transistor. Other configurations are possible, as is well-known by those skilled in the art. One of ordinary skill in the art would recognize upon review of the presently disclosed subject matter that other types of field-effect transistors, including, but not limited to, top gate field-effect transistors, could comprise the presently disclosed compound of Formula (I).

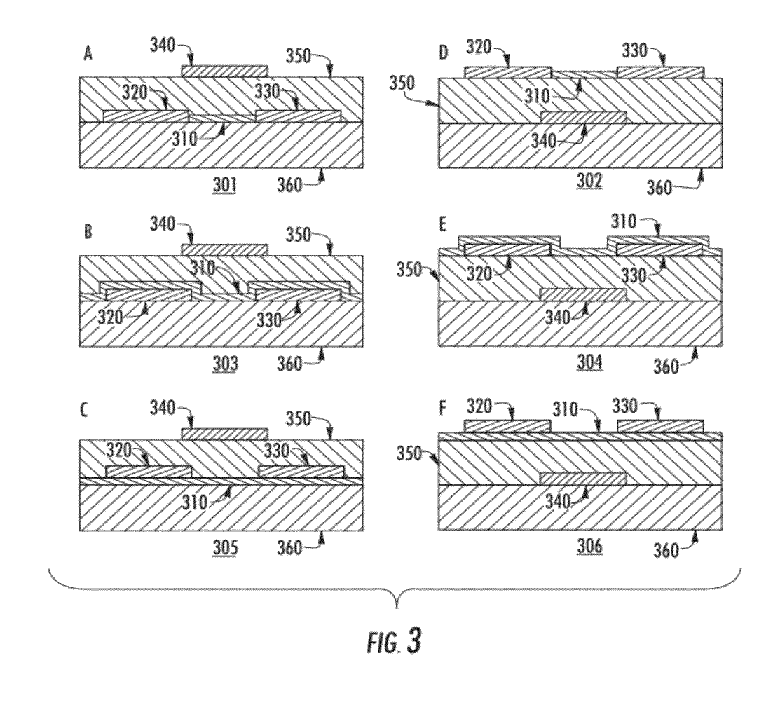

Referring now to FIGS. 3A-3F, representative embodiments of field-effect transistors comprising the presently disclosed compounds of Formula (I). In FIGS. 3A-3F, like numbers refer to like elements. More particularly, representative field-effect transistor devices 301, 302, 303, 304, 305, and 306 each comprise substrate 360, e.g., hexamethyldisilazane (HMDS)-treated or untreated SiO₂/Si substrates, gate insulating layer 350, gate electrode 340, drain electrode 330, source electrode 320, and a semiconductor layer 310, which comprises a compound of Formula (I).

Thin-film transistors comprising the presently disclosed compounds of Formula (I) can be used in several applications including, but not limited to, thin-film transistor liquid crystal displays. The following references can be used in practicing the various embodiments of the presently disclosed subject matter: Brabec, et al., Adv. Func. Mater. 2001, 11, 374-380; Sariciftci, N. S., Curr. Opinion in Solid State and Materials Science, 1999, 4, 373-378; Sariciftci, N., Materials Today 2004, 36; Hoppe, H. et al., J. Mater. Res. 2004, 19, 1924, Nakamura, et al., Applied Physics Letters 2005, 87, 132105; Paddinger et al., Advanced Functional Materials 2003, 13, No. 1, January, 85; Kim, et al., Photovoltaic Materials and Phenomena Scell 2004, 1371, J. Mater. Res., 2005, 20, No. 12, 3224; Inoue, et al., Mater. Res. Soc. Symp. Proc., 836, L.3.2.1; Li et al., J. Applied Physics 2005, 98, 043704.

iii. Electroluminescent Devices

Organic electroluminescent (OEL) devices, such as organic light emitting diodes, include an organic emissive element operationally positioned between two electrodes (e.g., an anode and a cathode). The organic emissive element of an organic electroluminescent device typically includes at least one light emitting layer that includes an electroluminescent material. Other layers also can be present in the organic emissive element, including, but not limited to, hole transport layers, electron transport layers, hole injection layers, electron injection layers, hole blocking layers, electron blocking layers, buffer layers, and the like. Further, photoluminescent materials can be present in the light emitting layer or other layers in the organic emissive element, for example, to convert the color of light emitted by the electroluminescent material to another color. These and other such layers and materials can be used to alter or tune the electronic properties and behavior of the layered OEL device. For example, the additional layers can be used to achieve a desired current/voltage response, a desired device efficiency, a desired color, a desired brightness, and the like.

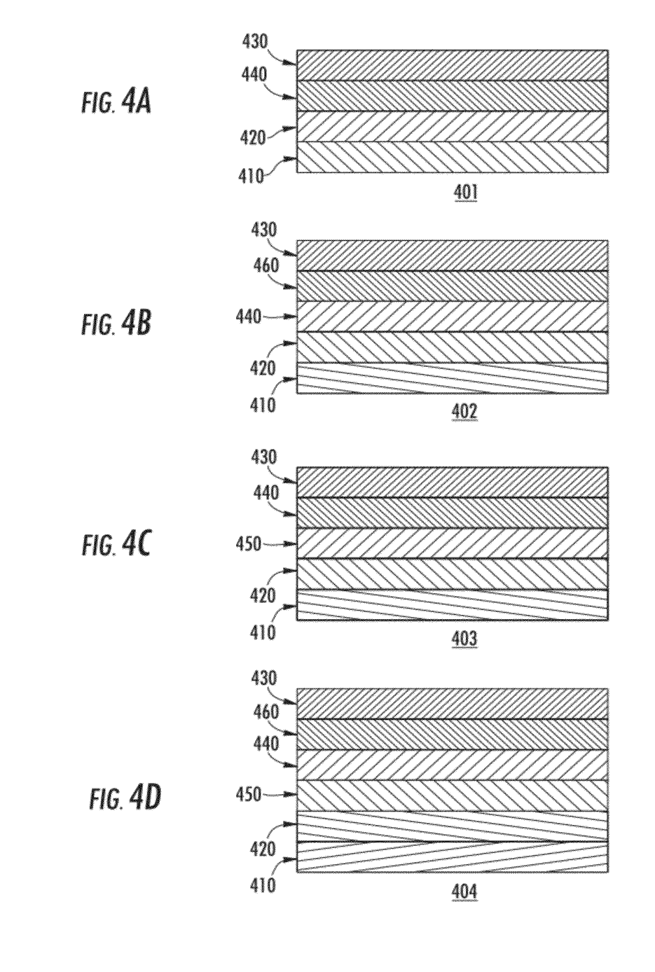

Referring now to FIGS. 4A-4D, representative embodiments of OEL devices, for example, an organic light emitting diode, comprising the presently disclosed compounds of Formula (I) are provided. Each device 400, 401, 402, 403, and 404 includes substrate 410, anode 420, cathode 430, and light emitting layer 440.

Anode 420 can be a transparent anode, such as indium tin oxide coated onto a plastic or glass substrate, as described hereinabove, which functions as a charge carrier and allows emission of a photon from the device by virtue of the anode's transparency. Cathode 430 typically is made of a low-work-function metal, such as calcium or aluminum, or both, as also described hereinabove. In some embodiments, the metal can be coated onto a supporting surface, such as a plastic or glass sheet. The second electrode conducts or injects electrons into the device.

Electroluminescent, or light emitting, layer (EL) 440 can be operationally positioned between the two electrodes. The electroluminescent layer (EL) can comprise, in some embodiments, materials based on polyphenylene vinylenes, polyfluorenes, and organic-transition metal small molecule complexes. The presently disclosed copolymers of Formula (I) also can be incorporated into the EL. Materials for use in the EL are generally chosen for the efficiency with which they emit photons when an exciton relaxes to the ground state through fluorescence or phosphorescence and for the wavelength or color of the light that they emit through the transparent electrode.

The embodiments shown in FIGS. 4C and 4D also include hole transport layer 450 and the embodiments shown in FIGS. 4B and 4D include electron transport layer 460. These layers conduct holes from the anode or electrons from the cathode, respectively. The presently disclosed compounds of Formula (I) can comprise the light emitting layer, the hole transport layer, or a combination thereof. Within any layer, the presently disclosed compounds of Formula (I) can be present alone or in combination with other materials.

Electroluminescent devices comprising the presently disclosed copolymers of Formula (I) can take a variety of forms. Devices that comprise electroluminescent polymers are commonly referred to as PLEDs (Polymer Light-Emitting Diodes). The electroluminescent layers (ELs) can be designed to emit white light, either for white lighting applications or to be color-filtered for a full-color display application. The EL layers also can also be designed to emit specific colors, such as red, green, and blue, which can then be combined to create the full spectrum of colors as seen by the human eye.

iv. Electrostatic Dissipation Coatings and Packaging Materials

In some embodiments, the presently disclosed copolymers of Formula (I) can be included in or used as electrostatic dissipation (ESD) coatings, ESD packaging materials, and other forms and applications of ESD materials. Electrostatic discharge is a common problem in many applications involving electronic devices. To minimize electrostatic discharge, conductive coatings, also known as ESD coatings, can be used to coat devices and device components. Conductive materials also can be blended into other materials, such as polymers, to form blends and packaging materials. The copolymers of Formula (I) can be used as a single polymeric component of an ESD coating or be combined (i.e., blended) with one or more additional chemical components.

In some embodiments, the ESD coating or ESD packaging material can be a blend of one or more polymers. In such ESD coatings, where a polymeric blend is used, the polymers are preferably compatible and soluble, dispersible or otherwise solution processable in a suitable solvent. Thus, in addition to a copolymer of Formula (I), the ESD coating can include one or more additional polymers. The additional polymer can be a synthetic polymer and, in some embodiments, can be a thermoplastic polymer. Representative additional polymers include, but are not limited to, organic polymers, synthetic polymers or oligomers, such as a polyvinyl polymer having a polymer side group, a poly(styrene) or a poly(styrene) derivative, poly(vinyl acetate) or its derivatives, poly(ethylene glycol) or its derivatives, such as poly(ethylene-co-vinyl acetate), poly(pyrrolidone) or its derivatives, such as poly(1-vinylpyrrolidone-co-vinyl acetate, poly(vinyl pyridine) or its derivatives, poly(methyl methacrylate) or its derivatives, poly(butyl acrylate) or its derivatives. More generally, the polymer can comprise a polymer or oligomer built from monomers, such as CH₂CH—Ar, where Ar can be any aryl or functionalized aryl group, isocyanates, ethylene oxides, conjugated dienes, CH₂CHR₁R (where R₁ can be alkyl, aryl, or alkylaryl, and R═H, alkyl, Cl, Br, F, OH, ester, acid, or ether), lactam, lactone, siloxanes, and ATRP macroinitiators. Representative examples include poly(styrene) and poly(4-vinyl pyridine). Another example is a water-soluble or water-dispersable polyurethane.

The molecular weight of the polymers in the coating can vary. In general, for example, the number average molecular weight of the polymers can be between about 5,000 and about 50,000. If desired, the number average molecular weight of the polymers can be for example about 5,000 to about 10,000,000, or about 5,000 to about 1,000,000.

In any of the aforementioned ESD coatings, at least one polymer can be cross-linked for various reasons including, but not limited to, improved chemical, mechanical or electrical properties.

For proper dissipation of static electricity the conductivity of the coating can be tuned. For example, the amount of a copolymer of Formula (I) in the coating can be increased or decreased. In addition, in some cases, doping can be used.

Application of the ESD coating can be achieved via spin coating, ink jetting, roll coating, gravure printing, dip coating, zone casting, or a combination thereof. In representative applications, the applied coating has a thickness greater than about 10 nm. In representative embodiments, the ESD coating can be applied to insulating surfaces, such as glass, silica, polymer or any other materials where static charge potentially can build up. Additionally, the polymer material can be blended into materials used to fabricate packaging film used for protection of, for example, sensitive electronic equipment. Such packaging films can be made by processing methodologies known in the art, such as, for example, blown film extrusion. Optical properties of the finished coating can vary depending on the type of blend and percent ratio of the polymers. Preferably, transparency of the coating is at least 90% over the wavelength region of 300 nm to 800 nm.

An ESD coating comprising the presently disclosed copolymer of Formula (I) can be applied to a wide variety of devices requiring static charge dissipation. Non-limiting examples include semiconductor devices and components, integrated circuits, display screens, projectors, aircraft wide screens, vehicular wide screens or CRT screens.

Other representative devices into which the presently disclosed copolymers of Formula (I) can be incorporated include, but are not limited to, shielding layers, bistable devices and memory devices, thin film semiconductor devices, such as photodetectors and photoconductors; electrochemical devices, such as rechargeable batteries, capacitors, supercapacitors, and electrochromic devices and sensors.

### B. Synthesis and Characterization

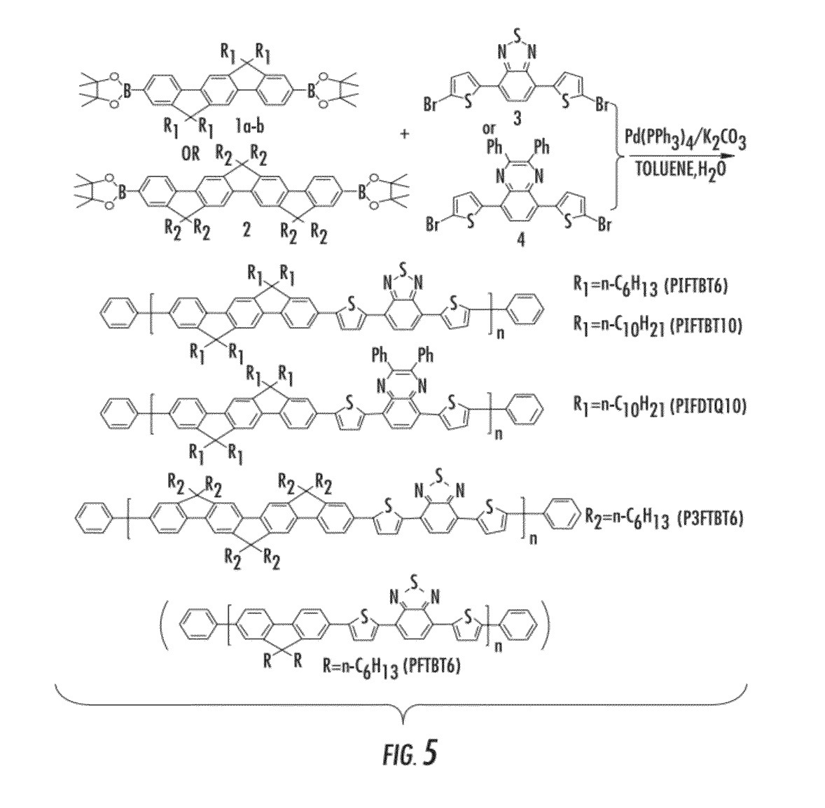

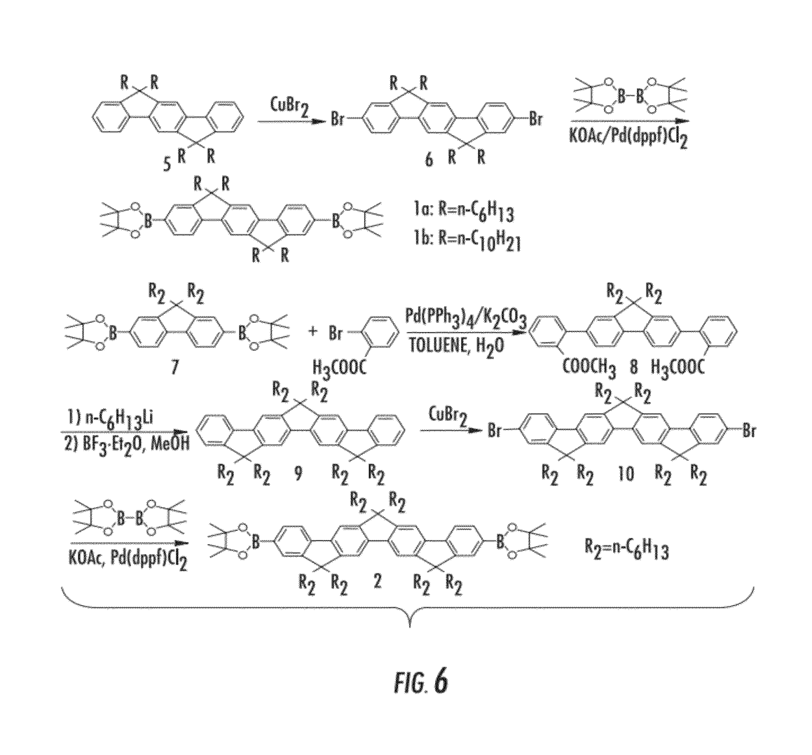

The syntheses of the representative copolymers of the presently disclosed subject matter are shown in FIG. 5. These compounds were prepared by a palladium-catalyzed Suzuki coupling reaction between 4,7-bis(5-bromo-2-thienyl)-2,1,3-benzothiadiazole (3) or 5,8-bis-(5-bromothiophen-2-yl)-2,3-diphenylquinoxaline (4), and three diboronated ladder-type oligo-p-phenylenes (1a-b, 2). For each copolymer, an end-capping reaction was performed using bromobenzene and phenyl boronic acid to increase the stability of the polymer. The synthesis of monomers 1a-b and 2 is outlined in FIG. 6. As shown in FIG. 6, the preparation of comonomers 1a-b started from compounds 5a-b, which were selectively brominated at the 2- and 8-positions, with copper(II) bromide on an aluminum oxide matrix in carbon tetrachloride affording 2,8-dibromo-6,6′,12,12′-tetraalkyl-6,12-dihydroindeno-[1,2b]-fluorene (6a-b). Then compounds 6a-b were reacted with 4,4,4′,4′,5,5,5′,5′-octamethyl-2,2′-bi(1,3,2-dioxaborolane) to yield compounds 1a-b with the aid of Pd(dppf)Cl₂. In the first step of the synthesis of comonomer 2, compound 8 was prepared by a 2-fold Suzuki coupling reaction between 2,7-bis(4,4,5,5-tetramethyl-1,3,2-dioxaborolan-2-yl)-9,9-dihexylfluorene (7) and methyl 2-bromobenzoate, using (PPh₃)₄Pd(0) as catalyst in a mixture of toluene and a aqueous solution of K₂CO₃ (2 M). Nucleophilic addition to the carboxylic ester (8) by n-hexyllithium gave the corresponding tertiary alcohol, and then the resulting tertiary alcohol was converted to compound 9 by a ring-closure reaction in the presence of boron trifluoride etherate, via an intramolecular Friedel-Crafts alkylation. In the third step, compound 9 was selectively brominated at the 2- and 8-positions by copper(II) bromide on an aluminum oxide matrix in carbon tetrachloride.

Finally compound 10 was reacted with 4,4,4′,4′,5,5,5′,5′-octamethyl-2,2′-bi(1,3,2-dioxaborolane) using catalytic amounts of Pd(dppf)Cl₂ and potassium acetate in DMF to provide compound 2. The synthesis of the acceptor comonomers, 4,7-bis(5-bromo-2-thienyl)-2,1,3-benzothiadiazole (3) and 5,8-bis(5-bromothiophen-2-yl)-2,3-diphenylquinoxaline (4), were prepared according to a literature procedure. Hou, Q., et al., J. Mater. Chem. 2002, 12, 2887-2892; Tsami, A., et al., J. Mater. Chem. 2007, 17, 1353-1355.

For comparison purposes, a fluorene-containing copolymer (PFTBT6) also was prepared as shown in FIG. 5. The structures of the polymers were determined with NMR spectroscopy. Gel permeation chromatography (GPC) results showed that these polymers have weight-averaged molecular weights of 21-64 kg/mol with polydispersity indexes (PDI) of 1.8-2.7 (Table 1). These polymers have very good solubility in many organic solvents, such as THF, toluene, chloroform, chlorobenzene, and the like, due to the four or six alkyl chains flanked on both sides of the oligo-p-phenylenes. For example, the solubility of the indenofluorene-containing copolymer in chlorobenzene is at least several times higher than its analogous fluorene-containing copolymer with the same side chains, which should facilitate the solution processing of solar cell devices, as well as other photovoltaic and opto-electronic devices.

TABLE 1
Molecular Weight and Optical Absorption of Representative
Presently Disclosed Polymers in Solution and Solid State^{a}

| | Mₙ | M_{w} | | absorption | | emission | | E_{g}^{opt} |
|---|---|---|---|---|---|---|---|---|
| polymers | (kg/mol) | (kg/mol) | PDI | solution | film | solution | film | (eV)^{b} |
| PIFTBT10 | 26.3 | 63.5 | 2.42 | 402, 542 | 399, | 613 | 618 | 1.97 |
| | | | | | 543 | | | |
| PIFDTQ10 | 7.8 | 21.0 | 2.65 | 400, 525 | 395, | 572 | 671 | 2.00 |
| | | | | | 530 | | | |
| PIFTBT6 | 22.5 | 45.9 | 2.03 | 402, 542 | 399, | 613 | 618 | 1.97 |
| | | | | | 541 | | | |
| P3FTBT6 | 14.2 | 24.9 | 1.75 | 415, 538 | 408, | 613 | 618 | 1.96 |
| | | | | | 531 | | | |

^{a}Polymers are dissolved in chlorobenzene for absorption and emission spectra of solution samples.
^{b}Estimated from the onset of the absorption spectra of thin films.

C. Optical Absorption and Photoluminescence

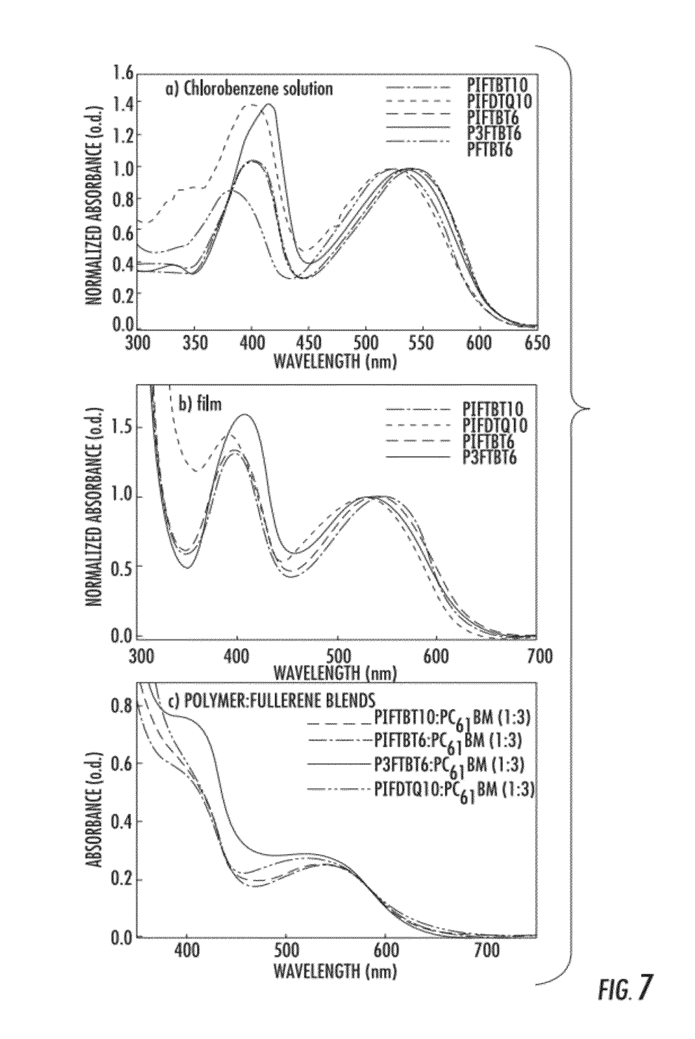

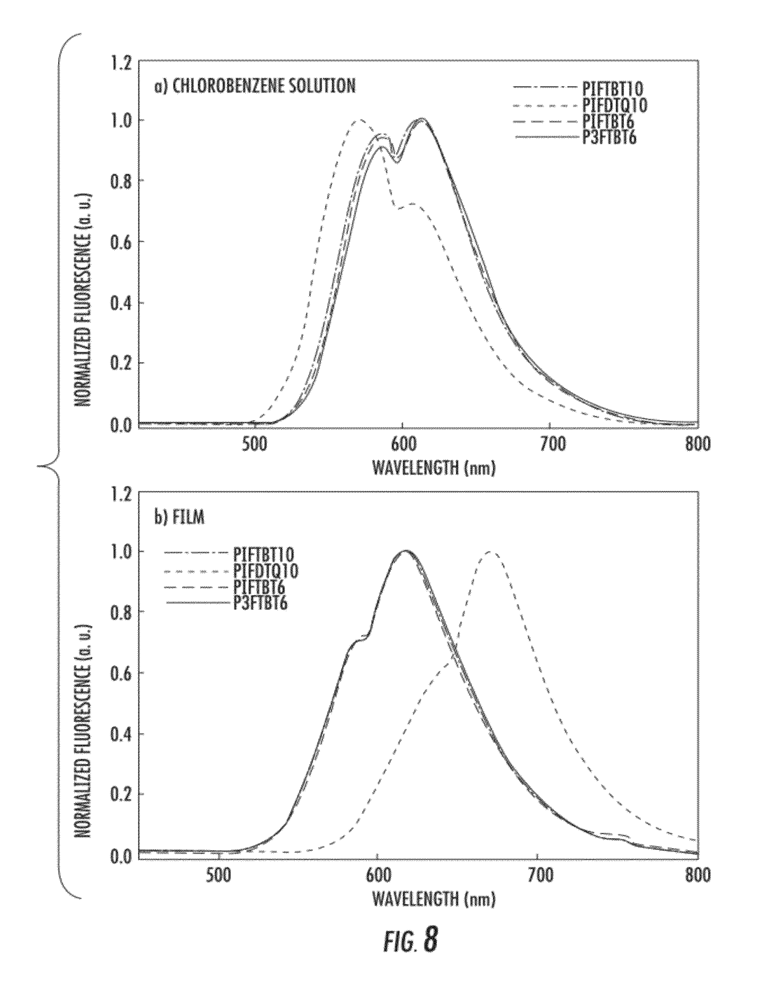

The optical absorption and emission spectra of the four representative polymer solutions (in chlorobenzene) are shown in FIG. 7a. For comparison, the absorption spectrum of PFTBT6 also is included in FIG. 7a. The pure polymer films and the films blended with PC₆₁BM (or PC₇₁BM) are shown in FIGS. 7b-7c. Similar to the fluorene containing polymer PFTBT6, each of the four presently disclosed copolymers exhibited two absorption peaks, which is a typical feature for donor-acceptor copolymers. As shown in FIG. 7a, the absorption peaks around 400 nm originate from the π-π* transition of indenofluorene or ladder-type tetra-p-phenylene units, while the absorption peaks around 540 nm come from the π-π* transition of the low band gap acceptor unit. Copolymers PIFTBT10 and PIFTBT6 have the same conjugated polymer backbone, but with different lengths of the alkyl chain substituents. As shown in FIG. 7a, their absorption spectra are identical indicating that the alkyl chains do not change the π-conjugated system of polymers. Compared to PFTBT6, both peaks of PIFTBT6 exhibit a bathochromic shift of about 16 nm to 19 nm due to the extended π-conjugated system by replacing a fluorene unit with an indenofluorene unit. At the same time, an increased absorption extinction coefficient was found for PIFTBT6 compared to that for PFTBT6. Further, the copolymer P3FTBT6 shows a more red-shifted linear absorption compared to PFTBT6 especially for the short wavelength peak, which exhibits a 32-nm shift from about 383 nm to about 415 nm. Besides the bathochromically shifted absorption band, the absorption extinction coefficient for P3FTBT6 at the short wavelength peak is nearly double compared to PFTBT6, which also suggests an improved sunlight absorption ability. The difference between PIFTBT10 and PIFDTQ10 is the acceptor unit. PIFTBT10 shows a redshifted linear absorption compared to PIFDTQ10 because the 4,7-dithien-2-yl-2,1,3-benzothiadiazole unit in PIFTBT10 is a stronger acceptor compared to the 5,8-dithien-2-yl-2,3-diphenylquinoxaline unit in PIFDTQ10. The three copolymers with the 4,7-dithien-2-yl-2,1,3-benzothiadiazole repeat unit show almost the same emission spectrum either in solution phase or in the solid film state (FIG. 8).

PIFDTQ10 exhibits an approximately 41-nm hypsochromically shifted emission compared to PIFTBT10 in a chlorobenzene solution. In the solid film state, however, PIFDTQ10 shows a 53-nm bathochromically shifted emission compared to PIFTBT10. This shift can be attributed to the two phenyl groups in the 5,8-dithien-2-yl-2,3-diphenylquinoxaline unit stretching out from the plane of the polymer backbone in the solution state, whereas in the solid state the two phenyl groups may be coplanar with the quinoxaline plane. For some polymers, such as P3HT, there is a large red shift of the absorption peak in going from solution phase to solid phase. The other three polymers with the 4,7-dithien-2-yl-2,1,3-benzothiadiazole repeat unit, however, show little difference for the absorption and emission spectra in solutions and solid state films. This lack of difference might be due to the more rigid polymer backbones in these three polymers, which prevent their conformal change in the solid state. For polymers PIFTBT10 and PIFTBT6, the optical band gap was found to be 1.97 eV as determined from the onset of the absorption spectra for the solid state films. The optical band gaps of PIFDTQ10 and P3FTBT6 were determined to be 2.00 and 1.96 eV, respectively. The optical absorption of the P3FTBT6/PC₆₁BM blend has an increased absorption extinction coefficient at approximately 400 nm compared to PIFTBT10 or PIFTBT6 blends with PC₆₁BM at the same blend ratio (polymer:PC₆₁BM) 1:3 by weight).

D. Electrochemical Study

For polymers used for solar cells, it is important to know the positions of their HOMO and LUMO levels. Cyclic voltammograms (CV) were performed in a three electrode cell using platinum electrodes at a scan rate of 50 mV s⁻¹ and a Ag/Ag⁺ (0.1 M of AgNO₃ in acetonitrile) reference electrode in an anhydrous and nitrogen-saturated solution of 0.1 M tetrabutylammonium tetrafluoroborate (Bu₄NBF₄) in acetonitrile. Under these conditions, the onset oxidation potential (E_{1/2} ox) of ferrocene was −0.02 V versus Ag/Ag⁺. The HOMO energy level of polymers was determined from the oxidation onset of the second scan from CV data. It is assumed that the redox potential of Fc/Fc⁺has an absolute energy level of −4.80 eV to vacuum. Pommerehne, J., et al., Adv. Mater. 1995, 7, 551-554.

The energy of HOMO and LUMO levels were calculated according to the following equations:

E_{HOMO}=−(φₒₓ+4.82)(eV) (eq. 3)

E_{LUMO}=−(φ_{red}+4.82)(eV) (eq. 4)

where φₒₓ and φ_{red} are the onset oxidation potential and the onset reduction potential vs Ag/Ag⁺, respectively.

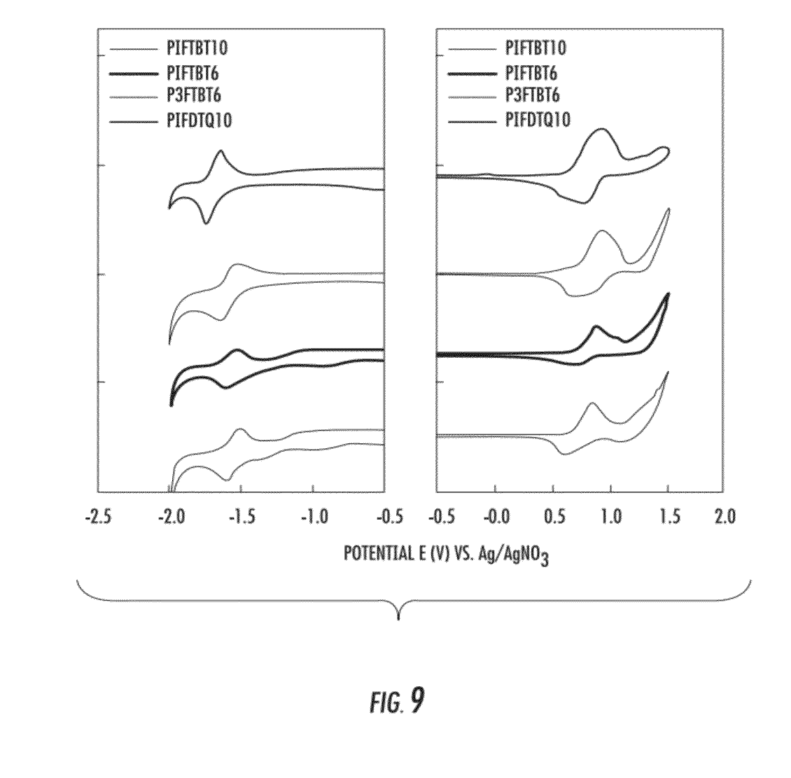

Cyclic voltammograms of these four polymers (PIFTBT10, PIFDTQ10, PIFTBT6, P3FTBT6) are shown in FIG. 9. Both reversible reduction and oxidation behaviors were observed for all four presently disclosed polymers, indicating the good structural stability of these polymers in the charged state. For PIFTBT10, the onset potentials for oxidation are located around +650 mV versus Ag/AgNO₃, which corresponds to a highest occupied molecular orbital of −5.47 eV. The LUMO energy level of PIFTBT10 is calculated to be approximately −3.44 eV based on the onset potential for reduction at around −1.37 eV. The electrochemical bandgap of PIFTBT10 is determined to be 2.03 eV, which is quite close to the band gap (1.97 eV) predicted by solid state optical absorption of the polymer films. The small difference (<0.1 eV) between electrochemical band gap and optical band gap for PIFTBT10 is similar to some other amorphous polymers, and it could be due to the more rigid polymer backbone for PIFTBT10 compared to other crystalline polymers (such as P3HT) that usually have larger differences between their electrochemical band gaps and optical band gaps. Wen, S., et al., Macromolecules 2009, 42 (14), 4977-4984. Using similar methods, the HOMO and LUMO levels and electrochemical band gaps for the other three polymers are calculated and listed in Table 2. The HOMO and LUMO energy levels of the four polymers are in good agreement with the optimal levels for obtaining good performance in photovoltaic cells using PC₆₁BM (LUMO: −3.7 eV) or PC₇₁BM (LUMO: −3.75 eV) as an acceptor. The deeper lying HOMO levels of these polymers should provide a higher open-circuit voltage (V_{oc}) according to the theoretical prediction. Scharber, M. C., et al., Adv. Mater. 2006, 18, 789-794.

TABLE 2
Electrochemical Properties of Representative Polymers^{a}

| | Eₒₓ | E_{red} | HOMO | LUMO | E_{g} |
|---|---|---|---|---|---|
| polymers | onset (V) | onset (V) | (eV) | (eV) | (eV) |
| PIFTBT10 | 0.65 | −1.38 | −5.47 | −3.44 | 2.03 |
| PIFDTQ10 | 0.63 | −1.46 | −5.45 | −3.36 | 2.09 |
| PIFTBT6 | 0.67 | −1.36 | −5.49 | −3.46 | 2.03 |
| P3FTBT6 | 0.63 | −1.36 | −5.45 | −3.45 | 2.00 |

^{a}Measured in a 0.1M solution of Bu₄NPF₆ in CH₃CN with a Pt electrode and a Ag/AgNO₃ reference electrode. In these conditions, the onset oxidation potential (E_{1/2} ox) of ferrocene was −0.02 V versus Ag/Ag⁺. It is assumed that the redox potential of Fc/Fc⁺ has an absolute energy level of −4.80 eV to vacuum.

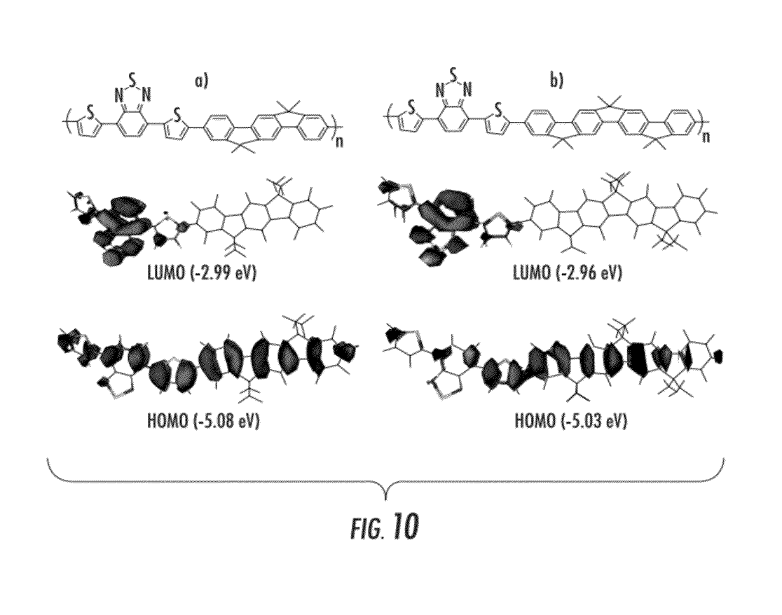

FIG. 10 depicts the electron-state-density distribution of the HOMO and LUMO of geometry optimized structures (DFTB3LYP/6-31G) of analogous monomers (a) PIFTBT6 (PIFTBT10), (b) P3FTBT6 using the Gaussian 03 program. The results indicate that the electron density of LUMO is mainly localized on the acceptor unit, while the electron density of HOMO is distributed over the entire conjugated molecule (both the acceptor unit and donor unit). Calculated results show that PIFTBT6 has a HOMO energy level of −5.08 eV, which is somewhat low-lying compared to P3FTBT6 (−5.03 eV), which has a half-fluorene extended π-conjugation system. These calculated changes for LUMO, HOMO levels and band gaps in going from PIFTBT6 (PIFTBT10) to P3FTBT6 also are in agreement with the experiment results.

E. Field Effect Transistors

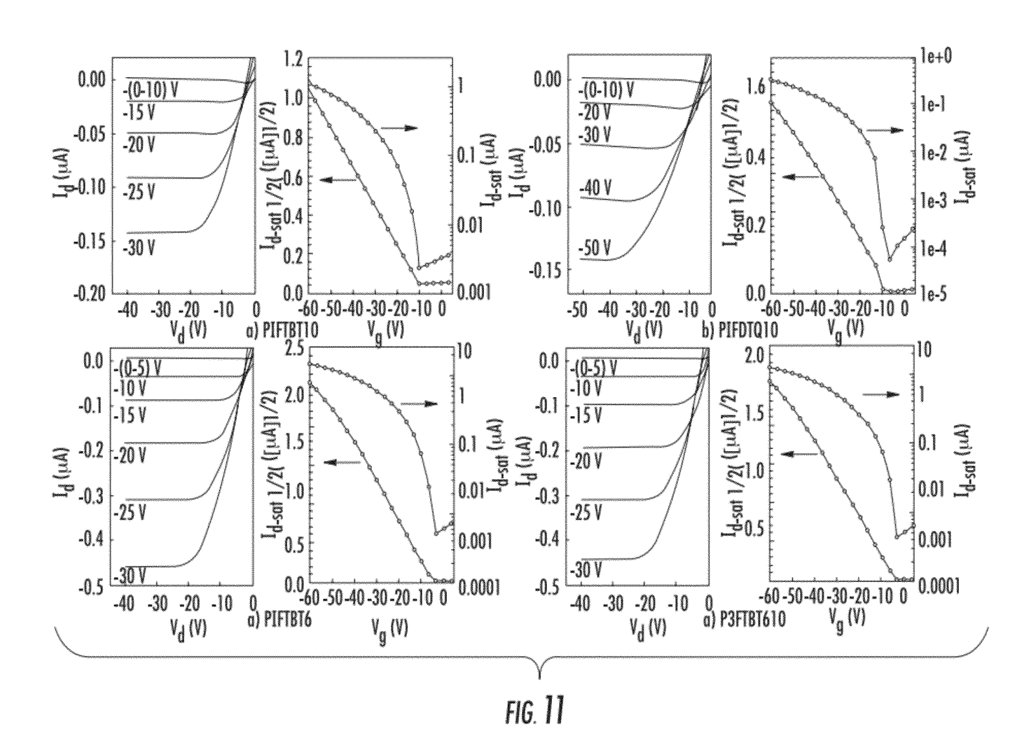

Among the requirements for polymer solar cells are an efficient photoinduced charge transfer from the donor molecules (polymers) to acceptors (such as PCBMs) and sufficient transport properties of the polymer blend. It has been demonstrated that PCBMs are good electron transporting materials with sufficient mobility for high performance solar cells. Mihailetchi, V. D., et al., Adv. Funct. Mater. 2003, 13, 43-46. Mobility measures the ease with which a charge carrier can move through a conducting material in response to an electric field. As opposed to free carrier concentrations, carrier mobility is determined in large part by intrinsic properties of the organic material. To ensure the hole-transporting properties of the presently disclosed polymers, field effect transistors (FETs) were fabricated. Top-contact bottom-gate transistors were fabricated under ambient conditions by spin-casting chlorobenzene solutions of the synthesized polymers on heavily doped Si(100) substrates treated with hexamethyldisilazane (HMDS) or without any surface treatment. FIGS. 11a-11d show the typical current-voltage characteristics of the polymeric FET devices with a channel width and length of approximately 6.5 mm and 270 μm, respectively, where I_{d}, V_{d}, V_{g} represent the source-drain current, source-drain voltage, and gate voltage, respectively.

The saturation region mobilities were calculated from the transfer characteristics of the FETs using the slope derived from the square root of the absolute value of the current as a function of gate voltage between −50 and −30 V. The threshold voltages of the polymeric FETs were derived from the onsets of the transfer curves. Device performance data of the four different presently disclosed polymers on two different surface treated substrates are listed in Table 3. From data presented in Table 3, the FETs devices with HMDS treatment gave 4- to 23-fold higher mobilities compared to those without surface treatment using the same polymer as the semiconducting material. Among the FET devices with HMDS treatment, the motilities for PIFTBT10, PIFDTQ10, PIFTBT6, and P3FTBT6 are found to be (4.2±0.2)×10⁻³, (9.5±0.7)×10⁻⁴, (1.1±0.1)×10⁻², and (9.7±0.3)×10⁻³ cm²/(Vs), in that order. All the devices show clear on/off behavior, which will minimize leakage currents. The structure difference in PIFTBT10 and PIFTBT6 is the length of the alkyl side chains on the linearly overlapping fluorene system.

TABLE 3
Mobilities, On-Off Current Ratios, and Threshold
Voltages of Polymer Based OFETs Measured in Air^{a}

| | Substrate | | Vₜₕ | |
|---|---|---|---|---|
| Polymers | treatment | μ (cm² V⁻¹ s⁻¹) | (V) | on/off |
| PIFTBT10 | none | (1.8 ± 0.4) × 10⁻⁴ | 7-25 | 10³ |
| PIFTBT10 | HMDS | (4.2 ± 0.2) × 10⁻³ | 6-12 | 10³ |
| PIFDTQ10 | none | (2.3 ± 0.2) × 10⁻⁴ | 3-13 | 10³ |
| PIFDTQ10 | HMDS | (9.5 ± 0.7) × 10⁻⁴ | 3-8 | 10³ |
| PIFTBT6 | none | (1.1 ± 0.1) × 10⁻³ | 3-10 | 10³ |
| PIFTBT6 | HMDS | (1.1 ± 0.1) × 10⁻² | 5-8 | 10³ |
| P3FTBT6 | none | (6.1 ± 0.5) × 10⁻⁴ | 1-13 | 10³ |
| P3FTBT6 | HMDS | (9.7 ± 0.3) × 10⁻³ | 4-7 | 10³ |

^{a}Threshold voltage (Vₜₕ). HMDS: hexamethyldisilazane.

A decrease of hole mobility with the longer alkyl chains also was observed. It is expected that more bulky side chains may increase the steric hindrance for the intermolecular packing, thus resulting in a decrease in mobility in going from PIFTBT6 to PIFTBT10. Comparing PIFTBT10 with PIFDTQ10, it is found that the mobility of the former is almost 5 times larger than the latter, which, without wishing to be bound to any one particular theory, might be attributed to the fact that two bulky phenyls in the 5,8-dithien-2-yl-2,3-diphenylquinoxaline repeat unit of PIFDTQ10 do not lead to a better π-π packing compared to PIFTBT10 with the 4,7-dithien-2-yl-2,1,3-benzothiadiazole repeat unit. For the three polymers with the 4,7-dithien-2-yl-2,1,3-benzothiadiazole repeat unit, PIFTBT6 and P3FTBT6 show over double the mobility compared to PIFTBT10. This enhanced mobility could be due to the π-π packing difference of the polymer backbone, as well as the morphological difference induced by the length of the side chains.

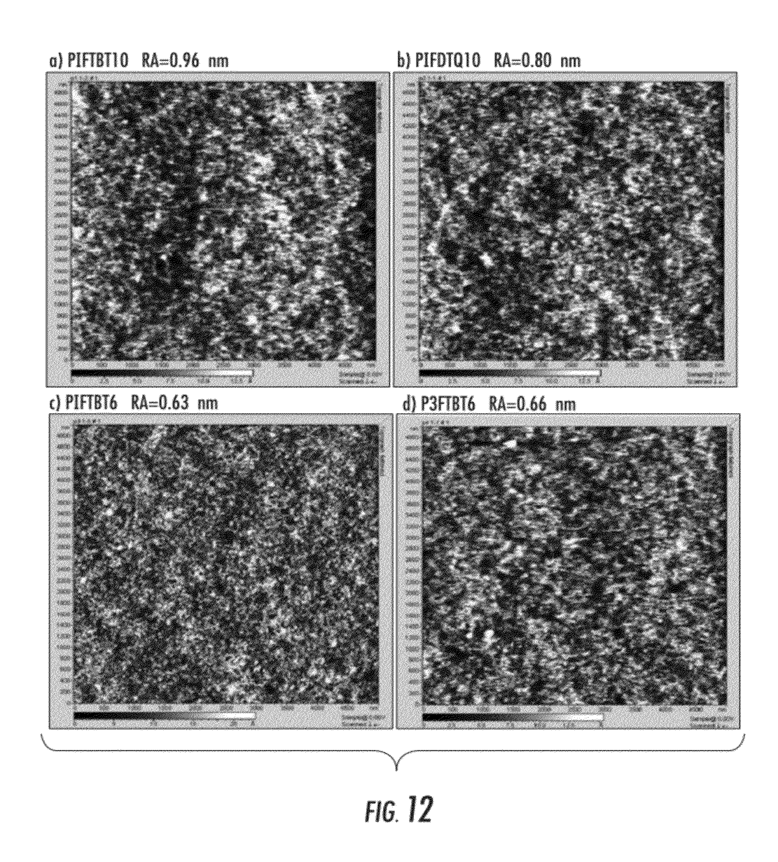

Atomic force microscopy (AFM) surface measurements of these films was performed, and the topographic images are shown in FIG. 12. In general, the AFM images of the four polymers show uniform and flat films with roughnesses in the range of about 0.6 nm to about 1.0 nm. Crystalline domains for these polymer films were not observed, indicating that all four presently disclosed polymers are amorphous. The films for polymers with longer side chains (PIFTBT10 and PIFDTQ10) show an increased roughness compared to the films for those with short alkyl chains (PIFTBT6 and P3FTBT6).

F. Solar Cells

As shown in the inset of FIG. 13a, the presently disclosed bulk heterojunction (BHJ) solar cells were fabricated with a device structure of ITO/PEDOT:PSS/polymer:fullerene/Cs₂CO₃/Al. After spin-coating an approximately 40-nm poly(ethylenedioxythiophene polystyrenesulfonate) (PEDOT:PSS) layer on the anode (ITO), the active layers with a thickness ranging from about 100 nm to about 180 nm were spin-coated from a mixed solvent (chlorobenzene:o-dichlorobenzene) 4:1) of polymers and fullerenes. Then the cathode, a bilayer of a thin (1.0 nm) Cs₂CO₃ layer covered with 100-nm Al, was thermally evaporated.

FIGS. 13a-13b show the current density-voltage (1-V) characteristics of photovoltaic devices based on the four presently disclosed polymer blends under simulated solar light (AM 1.5 G, 100 mW/cm², RT, ambient). Representative characteristics of the solar cells are summarized in Table 4. The cell based on BisDMOPFDTBT/PC₆₁BM serves as a standard reference for the solar cell performance of the four polymers disclosed herein. Chen, M.-H.; Hou, J.; Hong, Z.; Yang, G.; Sista, S.; Chen, L.-M.; Yang, Y. Adv. Mater. 2009, 21, 4238-4242. BisDMO-PFDTBT is a fluorene containing copolymer, which is exactly the same as PFTBT6 except the alkyl chains change from n-hexyl to 3,7-dimethyloctyl, which affords better solubility. Chen, M.-H., et al., Adv. Mater. 2009, 21, 4238-4242. PFTBT6 was not used due to its extremely low solubility in organic solvents. The data in Table 4 show all these polymers showed better performance than the analogous fluorene containing copolymers (BisDMO-PFDTBT) except for PIFTBT6. Compared to PIFTBT6, PIFTBT10, which contains longer side chains, has a higher power conversion efficiency of 2.44% with respect to 0.97% for PIFTBT6. This higher power conversion efficiency can be due to the solubility differences found for these two polymers, which may lead to their phase separation conditions. The hole mobility of PIFTBT6, however, is more than double that of PIFTBT10, indicating that the hole mobility of a polymer is not the only parameter for achieving high performance solar cells. At the same time, the presently disclosed results suggest that the length of the solubilizing group in the indenofluorene unit might play an important role in the solubility and miscibility with fullerene, which could lead to a difference in the nanoscale morphology of polymer-fullerene blends.

It is well recognized that the performance of solar cells is related to the nanoscale morphology of polymer-fullerene blends, which can be influenced by parameters including the solvent, the processing temperature, the solution concentration, the relative ratio in composition between polymer and fullerene, the thermal annealing process, the chemical structure of polymer, and the like. It should be noted that, since the conditions for the device fabrication of all the polymers have not yet been fully optimized, the data shown in Table 4 do not represent the best performance for all four presently disclosed polymers. The comparison here is merely based on one specific device fabrication condition. The different solar cell performances found for PIFTBT6 and PIFTBT10 show that the performance of this type of copolymer can be further improved by introducing some possibly better side chains, such as branched alkyl chains.

TABLE 4
Summary of Device Parameters of Representative
ITO/PEDOT:PSS/Polymer:Fullerene/Cs₂CO₃/Al Devices^{a}

| | blend ratio | | J_{sc} | | |
|---|---|---|---|---|---|
| | with | V_{oc} | (mA | fill | |
| Polymers | PC₆₁BM | (V) | cm⁻²) | factors | efficiencies |
| PIFDTQ10 | 1:3.0 | 1.01 | 5.53 | 0.42 | 2.32 |
| PIFDTQ10 | 1:3.5^{b} | 1.00 | 7.57 | 0.40 | 3.04 |
| PIFTBT10 | 1:3.0 | 1.00 | 6.10 | 0.40 | 2.44 |
| PIFTBT6 | 1:3.0 | 0.98 | 3.25 | 0.31 | 0.97 |
| P3FTBT6 | 1:3.0 | 1.06 | 6.73 | 0.39 | 2.81 |
| P3FTBT6 | 1:4.0 | 1.06 | 7.80 | 0.44 | 3.67 |
| P3FTBT6 | 1:4.0^{b} | 1.04 | 10.3 | 0.42 | 4.50 |
| BisDMO-PFDTBT | 1:3.0 | 0.94 | 4.45 | 0.42 | 1.75 |

^{a}Short-circuit current density (J_{sc}), open-circuit voltage (V_{oc}).
^{b}Blend with PC₇₁BM.

For PIFDTQ10, both PC₆₁BM and PC₇₁BM were chosen as acceptors in the active layer. PIFDTQ10 shows a high short circuit current (J_{sc}) of 7.57 mA/cm², an open-circuit voltage (V_{oc}) of 1.00 V, a fill factor of 0.40, and a power conversion efficiency (PCE) of 3.04% when it was blended with PC₇₁BM at a ratio of (1:3.5 by weight). In comparison, when it is blended with PC₆₁BM, a moderate J_{sc} of 5.53 mA/cm², a V_{oc} of 1.01 V, and a fill factor of 0.42 are achieved with the resulting power conversion efficiency of 2.32%. The increased efficiency for PIFDTQ10:PC₇₁BM can be attributed to the increasing optical absorption of the polymer blends, which leads to the increased short-circuit current. Wienk, M. M., et al., Angew. Chem., Int. Ed. 2003, 42, 3371-3375. P3FTBT6 and PIFTBT6 have the same side chains, but P3FTBT6 has an increased π-conjugation length (one-half the length of a fluorene). P3FTBT6:PC₆₁BM blends show a much higher power conversion efficiency of 2.81% in comparison to 0.97% for PIFTBT6:PC₆₁BM with the same device configuration. Surprisingly, the P3FTBT6:PC₆₁BM blends show a higher V_{oc} of 1.06 V compared to 0.98 V for PIFTBT6:PC₆₁BM, although the HOMO level of P3FTBT6 is in fact slightly higher than that for PIFTBT6.

P3FTBT6:PC₆₁BM solar cell devices also were fabricated with a higher fullerene blend ratio (1:4), and the results are shown in Table 4. Although no extensive optimization work has been carried out, an outstanding short-circuit current (J_{sc}) of 7.80 mA/cm² and a high open-circuit voltage (V_{oc}) of 1.06 V are achieved for the P3FTBT6 blends with PC₆₁BM (1:4). The best results were a power conversion efficiency of 3.67% and a fill factor of 0.44. Further, when PC₇₁BM was chosen as an electron acceptor material (P3FTBT6:PC₇₁BM) 1:4) for the solar cells, a short-circuit current (J_{sc}) of 10.3 mA/cm² and a high open-circuit voltage (V_{oc}) of 1.04 V are achieved yielding an outstanding power conversion efficiency of 4.5%. As shown in FIG. 13, devices fabricated from both blend ratios of P3FTBT6 to PC₆₁BM showed a high open-circuit voltage of 1.06 V. This observation indicated that V_{oc} is correlated not only to the difference between the HOMO of the donor and the LUMO of the acceptor but also to the molecular structural attributes of a polymer, such as rigidity and planarity. The open-circuit voltage of 1.06 V is higher than analogous donor-acceptor copolymers using fluorene (0.94 V) as the donor as shown in Table 4. It also is higher than other donor-acceptor copolymers using carbazoles (0.88 V) as the donor unit and much higher than the P3HT/PC₆₁BM system (0.60 V) with similar short circuit currents. Wen, S., et al., Macromolecules 2009, 42 (14), 4977-4984; Park, S. H., et al., Nat. Photonics 2009, 3, 297-302; Li, G., et al., Nat. Mater. 2005, 4, 864-868.

It should be pointed out that the presently disclosed devices are fabricated and tested in an ambient environment without any encapsulation. It is further acknowledged that the fill factors of the presently disclosed devices are not high (0.44), and the photocurrents in reverse bias show a mild field dependence due to the field-dependent exciton dissociation rate, and thus reduced fill factors. These low fill factors also can be attributed to the unbalanced transport of charge carriers and the relatively thick active polymer-fullerene layers (>100 nm) and high trap densities in the devices under ambient environment. An optical spacer or a hole blocker, such as titanium oxide (TiOx), between the active polymer-fullerene layer can be used to increase the fill factors of solar cell devices. Park, S. H., et al., Nat. Photonics 2009, 3, 297-302. Therefore, with all these considerations, as would be apparent to one of ordinary skill in the art, there should be opportunities to further optimize the solar cell performance by fabricating and testing devices in the glovebox, excluding oxygen and water to reduce traps, by engineering the active layer-electrode interface, and by carefully tracing sources of parasitic external resistances throughout the presently disclosed device structures.

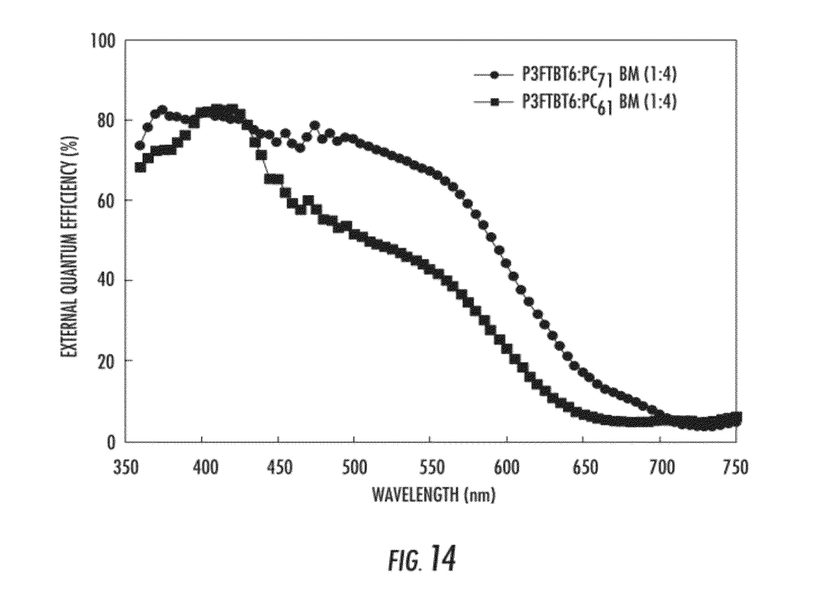

The external quantum efficiencies (EQE) as a function of wavelength of the photovoltaic cells based on P3FTBT6:PC₆₁BM (blue) and P3FTBT6:PC₇₁BM (red) are shown in FIG. 14. As shown in FIG. 14, the P3FTBT6:PC₆₁BM blend shows an EQE value of 0.82 at approximately 410 nm. This EQE peak is very close to the absorption peak (408 nm) of the copolymer, which indicates that the photovoltaic conversion arises from the absorption of the copolymer. For the device based on P3FTBT6:PC₇₁BM, increased EQE values are observed in the range of about 450 nm to about 700 nm, which is due to the increased absorption by PC₇₁BM compared to PC₆₁BM. The broader profile and higher values of EQE found for the P3FTBT6:PC₇₁BM are consistent with the higher J_{sc} measured in solar cells compared to P3FTBT6:PC₆₁BM.

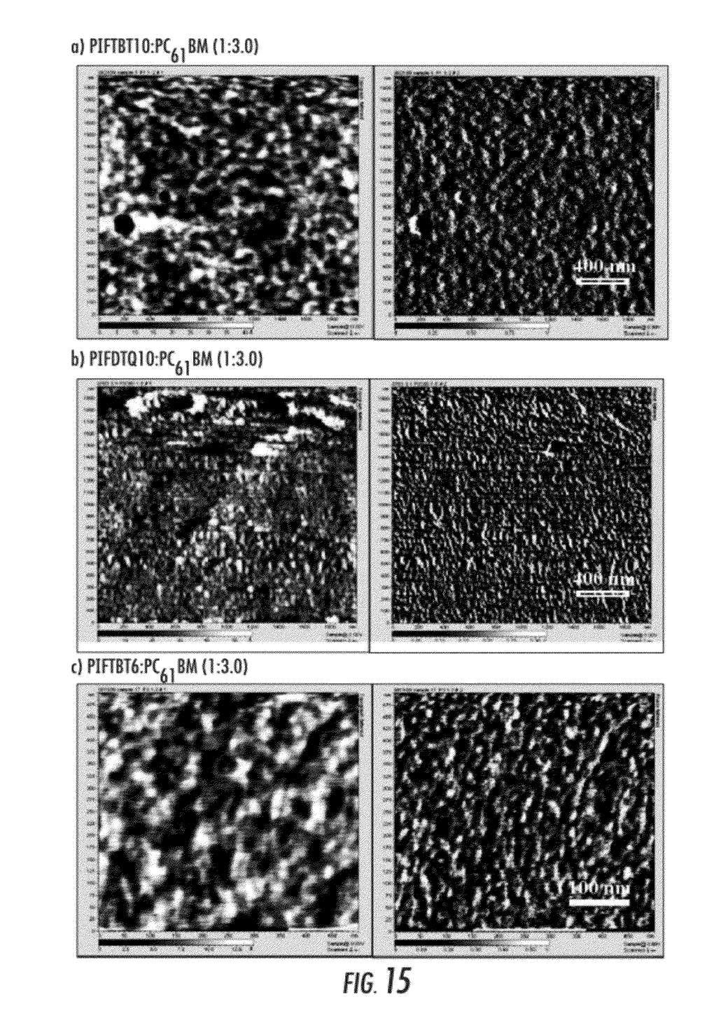

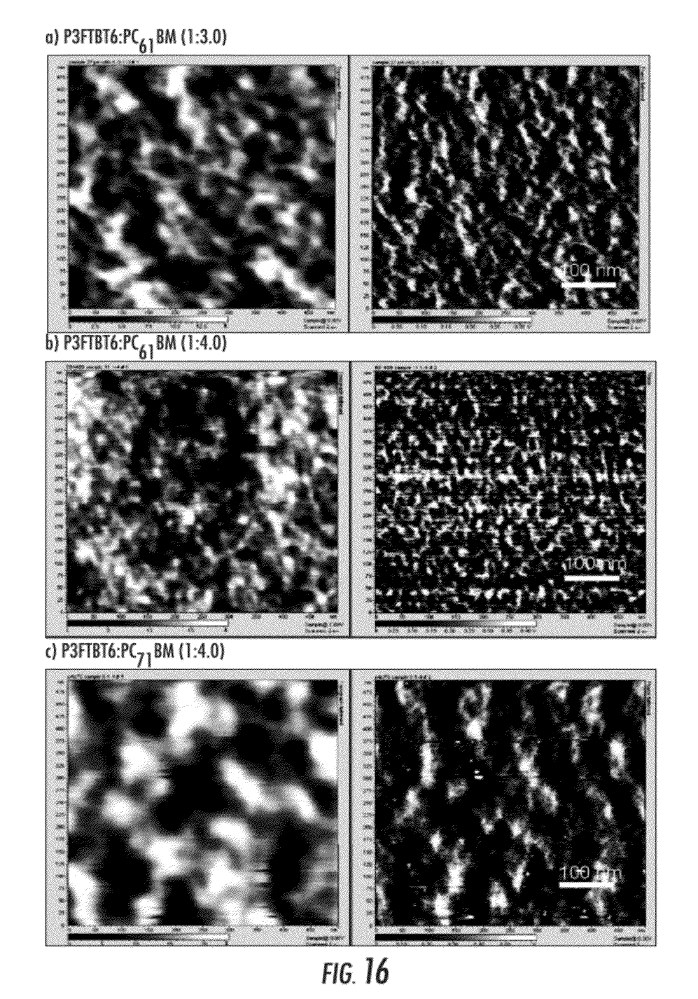

The morphological requirement for the active layer in high performance polymer solar cells (PSCs) is nanoscale phase separation, which enables a large interface area for exciton dissociation and, in the mean time, a continuous percolating path for hole and electron transport to the corresponding electrodes. In the presently disclosed subject matter, AFM was used to characterize the morphology of the polymer:PCBMs blends. Representative AFM topography and phase images are shown in FIGS. 15 and 16. As shown in FIGS. 15a and 15b, the AFM measurement demonstrates the nanoscale (>10 nm) phase separation for PIFTBT10:PC₆₁BM and PIFDTQ10:PC₆₁BM blends, which result in approximately 100-nm sized clusters for the blended films. Measurements on polymers:PC₆₁BM with different blend ratios reveal that the dark areas are attributed to PC₆₁BM domains. Phase separation with the formation of PC₆₁BM-rich domains facilitates an improved charge transport and carrier collection efficiency, which results in a reduction of recombination losses and an increase in short-circuit current density. From FIGS. 15 and 16, one may find that the length of side chains has some impact on the roughness, as well as the phase separation size. In general, longer alkyl chains (decyl) lead to an increased roughness as well as enlarged domain sizes. For PIFTBT10 and PIFDTQ10 with the 10-carbon alkyl chains, the roughness of the blend films with PC₆₁BM is in the range of about 3.5 nm to about 4.0 nm, whereas, for PIFTBT6 and P3FTBT6 with 6-carbon alkyl chains, the roughness is in the range of about 1.3 nm to about 41.5 nm. In FIG. 15a, PIFTBT10 is homogeneously distributed in the matrix with a domain size of approximately 20 nm in comparison to a domain size of 10 nm for PIFTBT6 in FIG. 15. As shown in FIGS. 16a and 16b, two different blend ratios of P3FTBT6 to PC₆₁BM led to different domain sizes of the films, as well as the shapes of the interpenetrated network. These morphology differences also are reflected by the photovoltaic behavior of the P3FTBT6:PC₆₁BM films. In FIG. 16b, for the P3FTBT6/PC₆₁BM blended film, the bright patterns of P3FTBT6 domains show an interpenetrating network, which enables a large interface area for exciton dissociation, as well as a continuous percolated path for hole and electron transport to the corresponding electrodes. This interpenetrating network might be responsible for the improved performance of the device from 2.81% (1:3) to 3.67% (1:4). FIG. 16c shows the AFM topography and phase images of P3FTBT6:PC₇₁BM. When the electron acceptor material changed from PC₆₁BM to PC₇₁BM, an increased roughness of approximately 2.5 nm is observed compared to 1.5 nm for P3FTBT6:PC₆₁BM, which could be due to the increased molecular size of PC₇₁BM. Pronounced nanoscale phase separation (>10 nm), however, is still observed for the P3FTBT6:PC₇₁BM blend.

G. Summary

In summary, a series of donor-acceptor ladder-type oligo-p-phenylene-containing co-polymers, PIFDTQ10, PIFTBT10, PIFTBT6, and P3FTBT6, have been synthesized. Incorporation of indenofluorene or ladder-type tetra-p-phenylene, an electron donating building block to the polymer backbone, leads to an enhanced and bathochromically shifted absorption band compared to the fluorene containing analogous copolymers. At the same time, the HOMO energy levels of the presently disclosed polymers were kept low, which results in a more than 60% increase in operating voltage compared to P3HT and many low band gap polymers. Even without extended optimization, a high power conversion efficiency of 3.67% and a high V_{oc} of 1.06 V were achieved from a P3FTBT6:PC₆₁BM (1:4) blend under the ambient environment, which is superior to that of the analogous fluorene containing copolymer (BisDMO-PFDTBT) cell (1.75%) under the same experimental conditions. A high power conversion efficiency of 4.50% and a high open-circuit voltage of 1.04 V also were achieved from a polymer solar cell device with an active layer containing 20 wt % P3FTBT6 and 80 wt % PC₇₁BM. The absorption range of this type of donor-acceptor copolymer can be further bathochromically tuned to better match the solar spectrum by using a still stronger acceptor. These results show that ladder-type oligo-p-phenylene containing copolymers are promising candidates for achieving BHJ solar cells with high conversion efficiencies and high open-circuit voltages.

### II. DEFINITIONS

Although specific terms are employed herein, they are used in a generic and descriptive sense only and not for purposes of limitation. Unless otherwise defined, all technical and scientific terms used herein have the same meaning as commonly understood by one of ordinary skill in the art to which this presently described subject matter belongs.

While the following terms in relation to compounds of Formula (I) are believed to be well understood by one of ordinary skill in the art, the following definitions are set forth to facilitate explanation of the presently disclosed subject matter. These definitions are intended to supplement and illustrate, not preclude, the definitions that would be apparent to one of ordinary skill in the art upon review of the present disclosure.

The terms substituted, whether preceded by the term “optionally” or not, and substituent, as used herein, refer to the ability, as appreciated by one skilled in this art, to change one functional group for another functional group provided that the valency of all atoms is maintained. When more than one position in any given structure may be substituted with more than one substituent selected from a specified group, the substituent may be either the same or different at every position. The substituents also may be further substituted (e.g., an aryl group substituent may have another substituent off it, such as another aryl group, which is further substituted, for example, with fluorine at one or more positions).

Where substituent groups or linking groups are specified by their conventional chemical formulae, written from left to right, they equally encompass the chemically identical substituents that would result from writing the structure from right to left, e.g., —CH₂O— is equivalent to —OCH₂—; —C(═O)O— is equivalent to —OC(═O)—; —OC(═O)NR— is equivalent to —NRC(═O)O—, and the like.

When the term “independently selected” is used, the substituents being referred to (e.g., R groups, such as groups R₁, R₂, and the like, or variables, such as “m” and “n”), can be identical or different.

The terms “a,” “an,” or “a(n),” when used in reference to a group of substituents herein, mean at least one. For example, where a compound is substituted with “an” alkyl or aryl, the compound is optionally substituted with at least one alkyl and/or at least one aryl. Moreover, where a moiety is substituted with an R substituent, the group may be referred to as “R-substituted.” Where a moiety is R-substituted, the moiety is substituted with at least one R substituent and each R substituent is optionally different.

A named “R” or group will generally have the structure that is recognized in the art as corresponding to a group having that name, unless specified otherwise herein. For the purposes of illustration, certain representative “R” groups as set forth above are defined below.

The descriptions of compounds of the present disclosure are limited by principles of chemical bonding known to those skilled in the art. Accordingly, where a group may be substituted by one or more of a number of substituents, such substitutions are selected so as to comply with principles of chemical bonding and to give compounds which are not inherently unstable and/or would be known to one of ordinary skill in the art as likely to be unstable under ambient conditions, such as aqueous, neutral, and several known physiological conditions. For example, a heterocycloalkyl or heteroaryl is attached to the remainder of the molecule via a ring heteroatom in compliance with principles of chemical bonding known to those skilled in the art thereby avoiding inherently unstable compounds.

The term hydrocarbon, as used herein, refers to any chemical group comprising hydrogen and carbon. The hydrocarbon may be substituted or unsubstituted. As would be known to one skilled in this art, all valencies must be satisfied in making any substitutions. The hydrocarbon may be unsaturated, saturated, branched, unbranched, cyclic, polycyclic, or heterocyclic. Illustrative hydrocarbons are further defined herein below and include, for example, methyl, ethyl, n-propyl, iso-propyl, cyclopropyl, allyl, vinyl, n-butyl, tert-butyl, ethynyl, cyclohexyl, methoxy, diethylamino, and the like.

The term “alkyl,” by itself or as part of another substituent, means, unless otherwise stated, a straight (i.e., unbranched) or branched chain, acyclic or cyclic hydrocarbon group, or combination thereof, which may be fully saturated, mono- or polyunsaturated and can include di- and multivalent groups, having the number of carbon atoms designated (i.e., C₁-C₁₀ means one to ten carbons). In particular embodiments, the term “alkyl” refers to C₁₋₃₀ inclusive, linear (i.e., “straight-chain”), branched, or cyclic, saturated or at least partially and in some cases fully unsaturated (i.e., alkenyl and alkynyl)hydrocarbon radicals derived from a hydrocarbon moiety containing between one and thirty carbon atoms by removal of a single hydrogen atom.

Representative saturated hydrocarbon groups include, but are not limited to, methyl, ethyl, n-propyl, isopropyl, n-butyl, isobutyl, sec-butyl, tert-butyl, n-pentyl, sec-pentyl, iso-pentyl, neopentyl, n-hexyl, sec-hexyl, n-heptyl, n-octyl, n-decyl, n-undecyl, dodecyl, cyclohexyl, (cyclohexyl)methyl, cyclopropylmethyl, and homologs and isomers thereof.

“Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁₋₈ straight-chain alkyls. In other embodiments, “alkyl” refers, in particular, to C₁₋₈ branched-chain alkyls.

Alkyl groups can optionally be substituted (a “substituted alkyl”) with one or more alkyl group substituents, which can be the same or different. The term “alkyl group substituent” includes but is not limited to alkyl, substituted alkyl, halo, arylamino, acyl, hydroxyl, aryloxyl, alkoxyl, alkylthio, arylthio, aralkyloxyl, aralkylthio, carboxyl, alkoxycarbonyl, oxo, and cycloalkyl. There can be optionally inserted along the alkyl chain one or more oxygen, sulfur or substituted or unsubstituted nitrogen atoms, wherein the nitrogen substituent is hydrogen, lower alkyl (also referred to herein as “alkylaminoalkyl”), or aryl.

Thus, as used herein, the term “substituted alkyl” includes alkyl groups, as defined herein, in which one or more atoms or functional groups of the alkyl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

The term “heteroalkyl,” by itself or in combination with another term, means, unless otherwise stated, a stable straight or branched chain, or cyclic hydrocarbon group, or combinations thereof, consisting of at least one carbon atoms and at least one heteroatom selected from the group consisting of O, N, P, Si and S, and wherein the nitrogen, phosphorus, and sulfur atoms may optionally be oxidized and the nitrogen heteroatom may optionally be quaternized. The heteroatom(s) O, N, P and S and Si may be placed at any interior position of the heteroalkyl group or at the position at which alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂₅—S(O)—CH₃, —CH₂—CH₂—S(O)₂—CH₃, —CH═CH—O—CH₃, —Si(CH₃)₃, —CH₂—CH═N—OCH₃, —CH═CH—N(CH₃)—CH₃, O—CH₃, —O—CH₂—CH₃, and —CN. Up to two or three heteroatoms may be consecutive, such as, for example, —CH₂—NH—OCH₃ and —CH₂—O—Si(CH₃)₃.

As described above, heteroalkyl groups, as used herein, include those groups that are attached to the remainder of the molecule through a heteroatom, such as —C(O)R′, —C(O)NR′, —NR′R″, —OR′, —SR, and/or —SO₂R′. Where “heteroalkyl” is recited, followed by recitations of specific heteroalkyl groups, such as —NR′R or the like, it will be understood that the terms heteroalkyl and —NR′R″ are not redundant or mutually exclusive. Rather, the specific heteroalkyl groups are recited to add clarity. Thus, the term “heteroalkyl” should not be interpreted herein as excluding specific heteroalkyl groups, such as —NR′R″ or the like.

“Cyclic” and “cycloalkyl” refer to a non-aromatic mono- or multicyclic ring system of about 3 to about 10 carbon atoms, e.g., 3, 4, 5, 6, 7, 8, 9, or 10 carbon atoms. The cycloalkyl group can be optionally partially unsaturated. The cycloalkyl group also can be optionally substituted with an alkyl group substituent as defined herein, oxo, and/or alkylene. There can be optionally inserted along the cyclic alkyl chain one or more oxygen, sulfur or substituted or unsubstituted nitrogen atoms, wherein the nitrogen substituent is hydrogen, alkyl, substituted alkyl, aryl, or substituted aryl, thus providing a heterocyclic group. Representative monocyclic cycloalkyl rings include cyclopentyl, cyclohexyl, and cycloheptyl. Multicyclic cycloalkyl rings include adamantyl, octahydronaphthyl, decalin, camphor, camphane, and noradamantyl, and fused ring systems, such as dihydro- and tetrahydronaphthalene, and the like.

The term “cycloalkylalkyl,” as used herein, refers to a cycloalkyl group as defined hereinabove, which is attached to the parent molecular moiety through an alkyl group, also as defined above. Examples of cycloalkylalkyl groups include cyclopropylmethyl and cyclopentylethyl.

The terms “cycloheteroalkyl” or “heterocycloalkyl” refer to a non-aromatic ring system, unsaturated or partially unsaturated ring system, such as a 3- to 10-member substituted or unsubstituted cycloalkyl ring system, including one or more heteroatoms, which can be the same or different, and are selected from the group consisting of nitrogen (N), oxygen (O), sulfur (S), phosphorus (P), and silicon (Si), and optionally can include one or more double bonds.

The cycloheteroalkyl ring can be optionally fused to or otherwise attached to other cycloheteroalkyl rings and/or non-aromatic hydrocarbon rings. Heterocyclic rings include those having from one to three heteroatoms independently selected from oxygen, sulfur, and nitrogen, in which the nitrogen and sulfur heteroatoms may optionally be oxidized and the nitrogen heteroatom may optionally be quaternized. In certain embodiments, the term heterocylic refers to a non-aromatic 5-, 6-, or 7-membered ring or a polycyclic group wherein at least one ring atom is a heteroatom selected from O, S, and N (wherein the nitrogen and sulfur heteroatoms may be optionally oxidized), including, but not limited to, a bi- or tri-cyclic group, comprising fused six-membered rings having between one and three heteroatoms independently selected from the oxygen, sulfur, and nitrogen, wherein (i) each 5-membered ring has 0 to 2 double bonds, each 6-membered ring has 0 to 2 double bonds, and each 7-membered ring has 0 to 3 double bonds, (ii) the nitrogen and sulfur heteroatoms may be optionally oxidized, (iii) the nitrogen heteroatom may optionally be quaternized, and (iv) any of the above heterocyclic rings may be fused to an aryl or heteroaryl ring. Representative cycloheteroalkyl ring systems include, but are not limited to pyrrolidinyl, pyrrolinyl, imidazolidinyl, imidazolinyl, pyrazolidinyl, pyrazolinyl, piperidyl, piperazinyl, indolinyl, quinuclidinyl, morpholinyl, thiomorpholinyl, thiadiazinanyl, tetrahydrofuranyl, and the like.

The terms “cycloalkyl” and “heterocycloalkyl”, by themselves or in combination with other terms, represent, unless otherwise stated, cyclic versions of “alkyl” and “heteroalkyl”, respectively. Additionally, for heterocycloalkyl, a heteroatom can occupy the position at which the heterocycle is attached to the remainder of the molecule. Examples of cycloalkyl include, but are not limited to, cyclopentyl, cyclohexyl, 1-cyclohexenyl, 3-cyclohexenyl, cycloheptyl, and the like. Examples of heterocycloalkyl include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like. The terms “cycloalkylene” and “heterocycloalkylene” refer to the divalent derivatives of cycloalkyl and heterocycloalkyl, respectively.

An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. Alkyl groups which are limited to hydrocarbon groups are termed “homoalkyl.”

More particularly, the term “alkenyl” as used herein refers to a monovalent group derived from a C₁₋₂₀ inclusive straight or branched hydrocarbon moiety having at least one carbon-carbon double bond by the removal of a single hydrogen atom. Alkenyl groups include, for example, ethenyl (i.e., vinyl), propenyl, butenyl, 1-methyl-2-buten-1-yl, pentenyl, hexenyl, octenyl, and butadienyl.

The term “cycloalkenyl” as used herein refers to a cyclic hydrocarbon containing at least one carbon-carbon double bond. Examples of cycloalkenyl groups include cyclopropenyl, cyclobutenyl, cyclopentenyl, cyclopentadiene, cyclohexenyl, 1,3-cyclohexadiene, cycloheptenyl, cycloheptatrienyl, and cyclooctenyl.

The term “alkynyl” as used herein refers to a monovalent group derived from a straight or branched C₁₋₂₀ hydrocarbon of a designed number of carbon atoms containing at least one carbon-carbon triple bond. Examples of “alkynyl” include ethynyl, 2-propynyl (propargyl), 1-propynyl, pentynyl, hexynyl, heptynyl, and allenyl groups, and the like.

The term “alkylene” by itself or a part of another substituent refers to a straight or branched bivalent aliphatic hydrocarbon group derived from an alkyl group having from 1 to about 20 carbon atoms, e.g., 1, 2, 3, 4, 5, 6, 7, 8, 9, 10, 11, 12, 13, 14, 15, 16, 17, 18, 19, or 20 carbon atoms. The alkylene group can be straight, branched or cyclic. The alkylene group also can be optionally unsaturated and/or substituted with one or more “alkyl group substituents.” There can be optionally inserted along the alkylene group one or more oxygen, sulfur or substituted or unsubstituted nitrogen atoms (also referred to herein as “alkylaminoalkyl”), wherein the nitrogen substituent is alkyl as previously described. Exemplary alkylene groups include methylene (—CH₂—); ethylene (—CH₂—CH₂—); propylene (—(CH₂)₃—); cyclohexylene (—C₆H₁₀—); CH═CH—CH═CH—; —CH═CH—CH₂—; —CH₂CH₂CH₂CH₂—, —CH₂CH═CHCH₂—, —CH₂CsCCH₂—, —CH₂CH₂CH(CH₂CH₂CH₃)CH₂—, —(CH₂)_{q}—N(R)—(CH₂)ᵣ—, wherein each of q and r is independently an integer from 0 to about 20, e.g., 0, 1, 2, 3, 4, 5, 6, 7, 8, 9, 10, 11, 12, 13, 14, 15, 16, 17, 18, 19, or 20, and R is hydrogen or lower alkyl; methylenedioxyl (—O—CH₂—O—); and ethylenedioxyl (—O—(CH₂)₂—O—). An alkylene group can have about 2 to about 3 carbon atoms and can further have 6-20 carbons. Typically, an alkyl (or alkylene) group will have from 1 to 24 carbon atoms, with those groups having 10 or fewer carbon atoms being some embodiments of the present disclosure. A “lower alkyl” or “lower alkylene” is a shorter chain alkyl or alkylene group, generally having eight or fewer carbon atoms.

The term “heteroalkylene” by itself or as part of another substituent means a divalent group derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxo, alkylenedioxo, alkyleneamino, alkylenediamino, and the like). Still further, for alkylene and heteroalkylene linking groups, no orientation of the linking group is implied by the direction in which the formula of the linking group is written. For example, the formula —C(O)OR′— represents both —C(O)OR′— and —R′OC(O)—.

The term “aryl” means, unless otherwise stated, an aromatic hydrocarbon substituent that can be a single ring or multiple rings (such as from 1 to 3 rings), which are fused together or linked covalently. The term “heteroaryl” refers to aryl groups (or rings) that contain from one to four heteroatoms (in each separate ring in the case of multiple rings) selected from N, O, and S, wherein the nitrogen and sulfur atoms are optionally oxidized, and the nitrogen atom(s) are optionally quaternized. A heteroaryl group can be attached to the remainder of the molecule through a carbon or heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of above noted aryl and heteroaryl ring systems are selected from the group of acceptable substituents described below.

The term “arylene” as used herein is intended to include divalent, carbocyclic, aromatic ring systems such as 6-membered monocyclic and 9- to 14-membered bi- and tricyclic, divalent, carbocyclic, aromatic ring systems. Representative examples of arylene compounds include, but are not limited to, phenylene, biphenylene, naphthylene, anthracenylene, phenanthrenylene, fluorenylene, indenylene, azulenylene, and the like. Arylene is also intended to include the partially hydrogenated derivatives of the ring systems enumerated above. Non-limiting examples of such partially hydrogenated derivatives are 1,2,3,4-tetrahydronaphthylene, 1,4-dihydronaphthylene, and the like.

The term “heteroarylene” as used herein is intended to include divalent, aromatic, heterocyclic ring systems containing one or more heteroatoms selected from nitrogen, oxygen and sulfur, such as 5- to 7-membered monocyclic and 8- to 14-membered bi- and tricyclic aromatic, heterocyclic ring systems containing one or more heteroatoms selected from nitrogen, oxygen and sulfur. Representative examples of heteroarylene divalent radicals include, but are not limited to, furylene, thienylene, pyrrolylene, oxazolylene, thiazolylene, imidazolylene, isoxazolylene, isothiazolylene, 1,2,3-triazolylene, 1,2,4-triazolylene, pyranylene, pyridylene, pyridazinylene, pyrimidinylene, pyrazinylene, 1,2,3-triazinylene, 1,2,4-triazinylene, 1,3,5-triazinylene, 1,2,3-oxadiazolylene, 1,2,4-oxadiazolylene, 1,2,5-oxadiazolylene, 1,3,4-oxadiazolylene, 1,2,3-thiadiazolylene, 1,2,4-thiadiazolylene, 1,2,5-thiadiazolylene, 1,3,4-thiadiazolylene, tetrazolylene, thiadiazinylene, indolylene, isoindolylene, benzofurylene, benzothienylene, indazolylene, benzimidazolylene, benzthiazolylene, benzisothiazolylene, benzoxazolylene, benzisoxazolylene, purinylene, quinazolinylene, quinolizinylene, quinolinylene, isoquinolinylene, quinoxalinylene, naphthyridinylene, pteridinylene, carbazolylene, azepinylene, diazepinylene, acridinylene, and the like. Heteroaryl also is intended to include the partially hydrogenated derivatives of the ring systems enumerated above. Non-limiting examples of such partially hydrogenated derivatives are 2,3-dihydrobenzofuranylene, pyrrolinylene, pyrazolinylene, indolinylene, oxazolidinylene, oxazolinylene, oxazepinylene, and the like.

In some embodiments, the heteroarylene divalent radical can include a “fused ring heterocyclic group,” in which a 5- to 7-membered cyclic group, for example, a 5- to 7-membered heteroaryl group described hereinabove, is fused with one or more other cyclic groups to form a bicyclic, tricyclic, or tetracyclic group, provided that at least one of the cyclic groups contains one or more heteroatoms (for example, from 1 to 3 heteroatoms) selected from a nitrogen atom, a sulfur atom and an oxygen atom in addition to carbon atoms, which has two positions available for bonding. Such fused ring heterocyclic groups, in some embodiments, can comprise the electron-accepting fused ring comprising the presently disclosed copolymers of Formula (I). Representative fused ring heterocyclic groups include, but not be limited to, acridinylene, benzimidazolylene, benzisothiazolylene, benzo[b]thienylene, benzo[c][1,2,5]oxadiazolylene, benzo[c][1,2,5]thiadiazolylene, benzo[c]isothiazolylene, benzo[c]isoxazolylene, benzo[c]thiophenylene, benzo[d][1,2,3]triazinylene. benzo[d][1,2,3]triazolylene, benzo[d]imidazolylene, benzo[e][1,2,3,4]tetrazinylene, benzo[e][1,2,4]triazinylene, benzofuranylene, benzotriazolylene, benzoxazolylene, bipyridylene, carbazolylene, f3-carbolinylene, cinnolinylene, dibenzo[b,d]thienylene, dibenzofuranylene, indazolylene, indenylene, indolizinylene, indolylene, isobenzofuranylene, isoindolylene, isoquinolinylene, naphthalenylene, naphtho[2,3-b]thiophenylene, naphthyridinylene, perimidinylene, phenanthridinylene, phenanthrolinylene, phenazinylene, phenothiazinylene, phenoxazinylene, phthalazinylene, pteridinylene, purinylene, quinazolinylene, quinolinylene, quinolizinylene, quinoxalinylene, and thianthrenylene.

For brevity, the term “aryl” when used in combination with other terms (e.g., aryloxo, arylthioxo, arylalkyl) includes both aryl and heteroaryl rings as defined above. Thus, the terms “arylalkyl” and “heteroarylalkyl” are meant to include those groups in which an aryl or heteroaryl group is attached to an alkyl group (e.g., benzyl, phenethyl, pyridylmethyl, furylmethyl, and the like) including those alkyl groups in which a carbon atom (e.g., a methylene group) has been replaced by, for example, an oxygen atom (e.g., phenoxymethyl, 2-pyridyloxymethyl, 3-(1-naphthyloxy)propyl, and the like). However, the term “haloaryl,” as used herein is meant to cover only aryls substituted with one or more halogens.

Where a heteroalkyl, heterocycloalkyl, or heteroaryl includes a specific number of members (e.g. “3 to 7 membered”), the term “member” refers to a carbon or heteroatom.

Further, a structure represented generally by the formula:

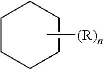

as used herein refers to a ring structure, for example, but not limited to a 3-carbon, a 4-carbon, a 5-carbon, a 6-carbon, a 7-carbon, and the like, aliphatic and/or aromatic cyclic compound, including a saturated ring structure, a partially saturated ring structure, and an unsaturated ring structure, comprising a substituent R group, wherein the R group can be present or absent, and when present, one or more R groups can each be substituted on one or more available carbon atoms of the ring structure. The presence or absence of the R group and number of R groups is determined by the value of the variable “n,” which is an integer generally having a value ranging from 0 to the number of carbon atoms on the ring available for substitution. Each R group, if more than one, is substituted on an available carbon of the ring structure rather than on another R group. For example, the structure above where n is 0 to 2 would comprise compound groups including, but not limited to:

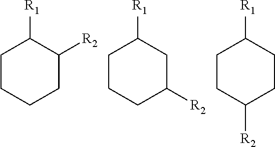

and the like.

A dashed line representing a bond in a cyclic ring structure indicates that the bond can be either present or absent in the ring. That is, a dashed line representing a bond in a cyclic ring structure indicates that the ring structure is selected from the group consisting of a saturated ring structure, a partially saturated ring structure, and an unsaturated ring structure.

The symbols ( [symbol] ) or (*-) denote the point of attachment of a moiety to the remainder of the molecule.

When a named atom of an aromatic ring or a heterocyclic aromatic ring is defined as being “absent,” the named atom is replaced by a direct bond.

Each of above terms (e.g., “alkyl,” “heteroalkyl,” “cycloalkyl, and “heterocycloalkyl”, “aryl,” “heteroaryl,” “phosphonate,” and “sulfonate” as well as their divalent derivatives) are meant to include both substituted and unsubstituted forms of the indicated group. Optional substituents for each type of group are provided below.

Substituents for alkyl, heteroalkyl, cycloalkyl, heterocycloalkyl monovalent and divalent derivative groups (including those groups often referred to as alkylene, alkenyl, heteroalkylene, heteroalkenyl, alkynyl, cycloalkyl, heterocycloalkyl, cycloalkenyl, and heterocycloalkenyl) can be one or more of a variety of groups selected from, but not limited to: —OR′, ═O, ═NR′, ═NR′R″, —SR′, -halogen, —SiR′R″R′″, —OC(O)R′, —C(O)R′, —CO₂R′, —C(O)NR′R″, —OC(O)NR′R″, —NR″C(O)R′, —NR′—C(O)NR″R′″, —NR″C(O)OR′, —NR—C(NR′R″)═NR′″, —S(O)R′, —S(O)₂R′, —S(O)₂NR′R″, —NRSO₂R′, —CN and —NO₂ in a number ranging from zero to (2m′+1), where m′ is the total number of carbon atoms in such groups. R′, R″, R′″ and R″″ each may independently refer to hydrogen, substituted or unsubstituted heteroalkyl, substituted or unsubstituted cycloalkyl, substituted or unsubstituted heterocycloalkyl, substituted or unsubstituted aryl (e.g., aryl substituted with 1-3 halogens), substituted or unsubstituted alkyl, alkoxy or thioalkoxy groups, or arylalkyl groups. As used herein, an “alkoxy” group is an alkyl attached to the remainder of the molecule through a divalent oxygen. When a compound of the disclosure includes more than one R group, for example, each of the R groups is independently selected as are each R′, R″, R′″ and R″″ groups when more than one of these groups is present. When R′ and R″ are attached to the same nitrogen atom, they can be combined with the nitrogen atom to form a 4-, 5-, 6-, or 7-membered ring. For example, —NR′R″ is meant to include, but not be limited to, 1-pyrrolidinyl and 4-morpholinyl. From the above discussion of substituents, one of skill in the art will understand that the term “alkyl” is meant to include groups including carbon atoms bound to groups other than hydrogen groups, such as haloalkyl (e.g., —CF₃ and —CH₂CF₃) and acyl (e.g., —C(O)CH₃, —C(O)CF₃, —C(O)CH₂OCH₃, and the like).

Similar to the substituents described for alkyl groups above, exemplary substituents for aryl and heteroaryl groups (as well as their divalent derivatives) are varied and are selected from, for example: halogen, —OR′, —NR′R″, —SR′, -halogen, —SiR′R″R″′, —OC(O)R′, —C(O)R′, —CO₂R′, —C(O)NR′R″, —OC(O)NR′R″, —NR″C(O)R′, —NR′—C(O)NR″R′″, —NR″C(O)OR′, —NR—C(NR′R″R′″)═NR″″, —NR—C(NR′R″)═NR″′—S(O)R′, —S(O)₂R′, —S(O)₂NR′R″, —NRSO₂R′, —CN and —NO₂, —R′, —N₃, —CH(Ph)₂, fluoro(C₁-C₄)alkoxo, and fluoro(C₁-C₄)alkyl, in a number ranging from zero to the total number of open valences on aromatic ring system; and where R′, R″, R′″ and R″″ may be independently selected from hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl and substituted or unsubstituted heteroaryl. When a compound of the disclosure includes more than one R group, for example, each of the R groups is independently selected as are each R′, R″, R″′ and R″″ groups when more than one of these groups is present.

Two of the substituents on adjacent atoms of aryl or heteroaryl ring may optionally form a ring of the formula -T-C(O)—(CRR′)_{q}—U—, wherein T and U are independently —NR—, —O—, —CRR′— or a single bond, and q is an integer of from 0 to 3. Alternatively, two of the substituents on adjacent atoms of aryl or heteroaryl ring may optionally be replaced with a substituent of the formula -A-(CH₂)ᵣ—B—, wherein A and B are independently —CRR′—, —O—, —NR—, —S—, —S(O)—, —S(O)₂—, —S(O)₂NR′— or a single bond, and r is an integer of from 1 to 4.

One of the single bonds of the new ring so formed may optionally be replaced with a double bond. Alternatively, two of the substituents on adjacent atoms of aryl or heteroaryl ring may optionally be replaced with a substituent of the formula —(CRR′)ₛ—X′— (C″R′″)_{d}—, where s and d are independently integers of from 0 to 3, and X′ is —O—, —NR″—, —S—, —S(O)—, —S(O)₂—, or —S(O)₂NR′—. The substituents R, R′, R″ and R′″ may be independently selected from hydrogen, substituted or unsubstituted alkyl, substituted or unsubstituted cycloalkyl, substituted or unsubstituted heterocycloalkyl, substituted or unsubstituted aryl, and substituted or unsubstituted heteroaryl.

As used herein, the term “acyl” refers to an organic acid group wherein the —OH of the carboxyl group has been replaced with another substituent and has the general formula RC(═O)—, wherein R is an alkyl, alkenyl, alkynyl, aryl, carbocylic, heterocyclic, or aromatic heterocyclic group as defined herein). As such, the term “acyl” specifically includes arylacyl groups, such as an acetylfuran and a phenacyl group. Specific examples of acyl groups include acetyl and benzoyl.

The terms “alkoxyl” or “alkoxy” are used interchangeably herein and refer to a saturated (i.e., alkyl-O—) or unsaturated (i.e., alkenyl-O— and alkynyl-O—) group attached to the parent molecular moiety through an oxygen atom, wherein the terms “alkyl,” “alkenyl,” and “alkynyl” are as previously described and can include C₁₋₂₀ inclusive, linear, branched, or cyclic, saturated or unsaturated oxo-hydrocarbon chains, including, for example, methoxyl, ethoxyl, propoxyl, isopropoxyl, n-butoxyl, sec-butoxyl, t-butoxyl, and n-pentoxyl, neopentoxy, n-hexoxy, and the like.

The term “alkoxyalkyl” as used herein refers to an alkyl-O-alkyl ether, for example, a methoxyethyl or an ethoxymethyl group.

“Aryloxyl” refers to an aryl-O— group wherein the aryl group is as previously described, including a substituted aryl. The term “aryloxyl” as used herein can refer to phenyloxyl or hexyloxyl, and alkyl, substituted alkyl, halo, or alkoxyl substituted phenyloxyl or hexyloxyl.

“Aralkyl” refers to an aryl-alkyl-group wherein aryl and alkyl are as previously described, and included substituted aryl and substituted alkyl. Exemplary aralkyl groups include benzyl, phenylethyl, and naphthylmethyl.

“Aralkyloxyl” refers to an aralkyl-O— group wherein the aralkyl group is as previously described. An exemplary aralkyloxyl group is benzyloxyl.

“Alkoxycarbonyl” refers to an alkyl-O—CO— group. Exemplary alkoxycarbonyl groups include methoxycarbonyl, ethoxycarbonyl, butyloxycarbonyl, and t-butyloxycarbonyl.

“Aryloxycarbonyl” refers to an aryl-O—CO— group. Exemplary aryloxycarbonyl groups include phenoxy- and naphthoxy-carbonyl.

“Aralkoxycarbonyl” refers to an aralkyl-O—CO— group. An exemplary aralkoxycarbonyl group is benzyloxycarbonyl.

“Carbamoyl” refers to an amide group of the formula —CONH₂. “Alkylcarbamoyl” refers to a R′RN—CO— group wherein one of R and R′ is hydrogen and the other of R and R′ is alkyl and/or substituted alkyl as previously described. “Dialkylcarbamoyl” refers to a R′RN—CO— group wherein each of R and R′ is independently alkyl and/or substituted alkyl as previously described.

The term carbonyldioxyl, as used herein, refers to a carbonate group of the formula —O—CO—OR.

“Acyloxyl” refers to an acyl-O— group wherein acyl is as previously described.

The term “amino” refers to the —NH₂ group and also refers to a nitrogen containing group as is known in the art derived from ammonia by the replacement of one or more hydrogen radicals by organic radicals. For example, the terms “acylamino” and “alkylamino” refer to specific N-substituted organic radicals with acyl and alkyl substituent groups respectively.

An “aminoalkyl” as used herein refers to an amino group covalently bound to an alkylene linker. More particularly, the terms alkylamino, dialkylamino, and trialkylamino as used herein refer to one, two, or three, respectively, alkyl groups, as previously defined, attached to the parent molecular moiety through a nitrogen atom. The term alkylamino refers to a group having the structure —NHR′ wherein R′ is an alkyl group, as previously defined; whereas the term dialkylamino refers to a group having the structure —NR′R″, wherein R′ and R″ are each independently selected from the group consisting of alkyl groups. The term trialkylamino refers to a group having the structure —NR′R″R′″, wherein R′, R″, and R″ are each independently selected from the group consisting of alkyl groups. Additionally, R′, R″, and/or R″ taken together may optionally be —(CH₂)ₖ— where k is an integer from 2 to 6. Examples include, but are not limited to, methylamino, dimethylamino, ethylamino, diethylamino, diethylaminocarbonyl, methylethylamino, iso-propylamino, piperidino, trimethylamino, and propylamino.

The amino group is —NR′R″, wherein R′ and R″ are typically selected from hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl.

The terms alkylthioether and thioalkoxyl refer to a saturated (i.e., alkyl-S—) or unsaturated (i.e., alkenyl-S— and alkynyl-S—) group attached to the parent molecular moiety through a sulfur atom. Examples of thioalkoxyl moieties include, but are not limited to, methylthio, ethylthio, propylthio, isopropylthio, n-butylthio, and the like.

“Acylamino” refers to an acyl-NH— group wherein acyl is as previously described. “Aroylamino” refers to an aroyl-NH— group wherein aroyl is as previously described.

The term “carbonyl” refers to the —(C═O)— group.

The term “carboxyl” refers to the —COOH group. Such groups also are referred to herein as a “carboxylic acid” moiety.

The terms “halo,” “halide,” or “halogen” as used herein refer to fluoro, chloro, bromo, and iodo groups. Additionally, terms such as “haloalkyl,” are meant to include monohaloalkyl and polyhaloalkyl. For example, the term “halo(C₁-C₄)alkyl” is mean to include, but not be limited to, trifluoromethyl, 2,2,2-trifluoroethyl, 4-chlorobutyl, 3-bromopropyl, and the like.

The term “hydroxyl” refers to the —OH group.

The term “hydroxyalkyl” refers to an alkyl group substituted with an —OH group.

The term “mercapto” refers to the —SH group.

The term “oxo” as used herein means an oxygen atom that is double bonded to a carbon atom or to another element.

The term “nitro” refers to the —NO₂ group.

The term “thio” refers to a compound described previously herein wherein a carbon or oxygen atom is replaced by a sulfur atom.

The term “sulfate” refers to the —SO₄ group.

The term thiohydroxyl or thiol, as used herein, refers to a group of the formula —SH.

The term ureido refers to a urea group of the formula —NH—CO—NH₂.

Unless otherwise explicitly defined, a “substituent group,” as used herein, includes a functional group selected from one or more of the following moieties, which are defined herein:

(A) —OH, —NH₂, —SH, —CN, —CF₃, —NO₂, oxo, halogen, unsubstituted alkyl, unsubstituted heteroalkyl, unsubstituted cycloalkyl, unsubstituted heterocycloalkyl, unsubstituted aryl, unsubstituted heteroaryl, and

(B) alkyl, heteroalkyl, cycloalkyl, heterocycloalkyl, aryl, and heteroaryl, substituted with at least one substituent selected from:

(i) oxo, —OH, —NH₂, —SH, —CN, —CF₃, —NO₂, halogen, unsubstituted alkyl, unsubstituted heteroalkyl, unsubstituted cycloalkyl, unsubstituted heterocycloalkyl, unsubstituted aryl, unsubstituted heteroaryl, and

(ii) alkyl, heteroalkyl, cycloalkyl, heterocycloalkyl, aryl, and heteroaryl, substituted with at least one substituent selected from:

(a) oxo, —OH, —NH₂, —SH, —CN, —CF₃, —NO₂, halogen, unsubstituted alkyl, unsubstituted heteroalkyl, unsubstituted cycloalkyl, unsubstituted heterocycloalkyl, unsubstituted aryl, unsubstituted heteroaryl, and

(b) alkyl, heteroalkyl, cycloalkyl, heterocycloalkyl, aryl, or heteroaryl, substituted with at least one substituent selected from oxo, —OH, —NH₂, —SH, —CN, —CF₃, —NO₂, halogen, unsubstituted alkyl, unsubstituted heteroalkyl, unsubstituted cycloalkyl, unsubstituted heterocycloalkyl, unsubstituted aryl, and unsubstituted heteroaryl.

A “lower substituent” or “lower substituent group,” as used herein means a group selected from all of the substituents described hereinabove for a “substituent group,” wherein each substituted or unsubstituted alkyl is a substituted or unsubstituted C₁-C₈ alkyl, each substituted or unsubstituted heteroalkyl is a substituted or unsubstituted 2 to 8 membered heteroalkyl, each substituted or unsubstituted cycloalkyl is a substituted or unsubstituted C₅-C₇ cycloalkyl, and each substituted or unsubstituted heterocycloalkyl is a substituted or unsubstituted 5 to 7 membered heterocycloalkyl.

A “size-limited substituent” or “size-limited substituent group,” as used herein means a group selected from all of the substituents described above for a “substituent group,” wherein each substituted or unsubstituted alkyl is a substituted or unsubstituted C₁-C₂₀ alkyl, each substituted or unsubstituted heteroalkyl is a substituted or unsubstituted 2 to 20 membered heteroalkyl, each substituted or unsubstituted cycloalkyl is a substituted or unsubstituted C₄-C₈ cycloalkyl, and each substituted or unsubstituted heterocycloalkyl is a substituted or unsubstituted 4 to 8 membered heterocycloalkyl.

As used herein, an “analog” refers to a chemical compound in which one or more individual atoms or functional groups of a parent compound have been replaced, either with a different atom or with a different functional group. For example, thiophene is an analog of furan, in which the oxygen atom of the five-membered ring is replaced by a sulfur atom.

As used herein, a “derivative” refers to a chemical compound which is derived from or obtained from a parent compound and contains essential elements of the parent compound but typically has one or more different functional groups. Such functional groups can be added to a parent compound, for example, to improve the molecule's solubility, absorption, biological half life, and the like, or to decrease the toxicity of the molecule, eliminate or attenuate any undesirable side effect of the molecule, and the like. An example of a derivative is an ester or amide of a parent compound having a carboxylic acid functional group.

Throughout the specification and claims, a given chemical formula or name shall encompass all tautomers, congeners, and optical- and stereoisomers, as well as racemic mixtures where such isomers and mixtures exist.

Certain compounds of the present disclosure possess asymmetric carbon atoms (optical or chiral centers) or double bonds; the enantiomers, racemates, diastereomers, tautomers, geometric isomers, stereoisometric forms that may be defined, in terms of absolute stereochemistry, as (R)- or (S)- or, as (D)- or (L)- for amino acids, and individual isomers are encompassed within the scope of the present disclosure. The compounds of the present disclosure do not include those which are known in art to be too unstable to synthesize and/or isolate. The present disclosure is meant to include compounds in racemic and optically pure forms. Optically active (R)- and (S)-, or (D)- and (L)-isomers may be prepared using chiral synthons or chiral reagents, or resolved using conventional techniques. When the compounds described herein contain olefenic bonds or other centers of geometric asymmetry, and unless specified otherwise, it is intended that the compounds include both E and Z geometric isomers.

Unless otherwise stated, structures depicted herein are also meant to include all stereochemical forms of the structure; i.e., the R and S configurations for each asymmetric center. Therefore, single stereochemical isomers as well as enantiomeric and diastereomeric mixtures of the present compounds are within the scope of the disclosure.

It will be apparent to one skilled in the art that certain compounds of this disclosure may exist in tautomeric forms, all such tautomeric forms of the compounds being within the scope of the disclosure. The term “tautomer,” as used herein, refers to one of two or more structural isomers which exist in equilibrium and which are readily converted from one isomeric form to another.

Unless otherwise stated, structures depicted herein are also meant to include compounds which differ only in the presence of one or more isotopically enriched atoms. For example, compounds having the present structures except for the replacement of a hydrogen by a deuterium or tritium, or the replacement of a carbon by ¹³C- or ¹⁴C-enriched carbon are within the scope of this disclosure.

The compounds of the present disclosure also can contain unnatural proportions of atomic isotopes at one or more of atoms that constitute such compounds. For example, the compounds may be radiolabeled with radioactive isotopes, such as for example tritium (³H), iodine-125 (¹²⁵I) or carbon-14 (¹⁴C). All isotopic variations of the compounds of the present disclosure, whether radioactive or not, are encompassed within the scope of the present disclosure.

As used herein the term “monomer” refers to a molecule that can undergo polymerization, thereby contributing constitutional units to the essential structure of a macromolecule or polymer.

A “polymer” is a molecule of high relative molecule mass, the structure of which essentially comprises the multiple repetition of unit derived from molecules of low relative molecular mass, i.e., a monomer.

As used herein, an “oligomer” includes a few monomer units, for example, in contrast to a polymer that potentially can comprise an unlimited number of monomers. Dimers, trimers, and tetramers are non-limiting examples of oligomers.

The compounds of the present disclosure may exist as salts. The present disclosure includes such salts. Examples of applicable salt forms include hydrochlorides, hydrobromides, sulfates, methanesulfonates, nitrates, maleates, acetates, citrates, fumarates, tartrates (e.g. (+)-tartrates, (−)-tartrates or mixtures thereof including racemic mixtures, succinates, benzoates and salts with amino acids such as glutamic acid. These salts may be prepared by methods known to those skilled in art. Also included are base addition salts such as sodium, potassium, calcium, ammonium, organic amino, or magnesium salt, or a similar salt. When compounds of the present disclosure contain relatively basic functionalities, acid addition salts can be obtained by contacting the neutral form of such compounds with a sufficient amount of the desired acid, either neat or in a suitable inert solvent. Examples of acceptable acid addition salts include those derived from inorganic acids like hydrochloric, hydrobromic, nitric, carbonic, monohydrogencarbonic, phosphoric, monohydrogenphosphoric, dihydrogenphosphoric, sulfuric, monohydrogensulfuric, hydriodic, or phosphorous acids and the like, as well as the salts derived organic acids like acetic, propionic, isobutyric, maleic, malonic, benzoic, succinic, suberic, fumaric, lactic, mandelic, phthalic, benzenesulfonic, p-tolylsulfonic, citric, tartaric, methanesulfonic, and the like. Also included are salts of amino acids such as arginate and the like, and salts of organic acids like glucuronic or galactunoric acids and the like. Certain specific compounds of the present disclosure contain both basic and acidic functionalities that allow the compounds to be converted into either base or acid addition salts.

The neutral forms of the compounds may be regenerated by contacting the salt with a base or acid and isolating the parent compound in the conventional manner. The parent form of the compound differs from the various salt forms in certain physical properties, such as solubility in polar solvents.

Certain compounds of the present disclosure can exist in unsolvated forms as well as solvated forms, including hydrated forms. In general, the solvated forms are equivalent to unsolvated forms and are encompassed within the scope of the present disclosure. Certain compounds of the present disclosure may exist in multiple crystalline or amorphous forms. In general, all physical forms are equivalent for the uses contemplated by the present disclosure and are intended to be within the scope of the present disclosure.

The term “protecting group” refers to chemical moieties that block some or all reactive moieties of a compound and prevent such moieties from participating in chemical reactions until the protective group is removed, for example, those moieties listed and described in T. W. Greene, P. G. M. Wuts, Protective Groups in Organic Synthesis, 3rd ed. John Wiley & Sons (1999). It may be advantageous, where different protecting groups are employed, that each (different) protective group be removable by a different means. Protective groups that are cleaved under totally disparate reaction conditions allow differential removal of such protecting groups. For example, protective groups can be removed by acid, base, and hydrogenolysis. Groups such as trityl, dimethoxytrityl, acetal and tert-butyldimethylsilyl are acid labile and may be used to protect carboxy and hydroxy reactive moieties in the presence of amino groups protected with Cbz groups, which are removable by hydrogenolysis, and Fmoc groups, which are base labile. Carboxylic acid and hydroxy reactive moieties may be blocked with base labile groups such as, without limitation, methyl, ethyl, and acetyl in the presence of amines blocked with acid labile groups such as tert-butyl carbamate or with carbamates that are both acid and base stable but hydrolytically removable.

Carboxylic acid and hydroxy reactive moieties may also be blocked with hydrolytically removable protective groups such as the benzyl group, while amine groups capable of hydrogen bonding with acids may be blocked with base labile groups such as Fmoc. Carboxylic acid reactive moieties may be blocked with oxidatively-removable protective groups such as 2,4-dimethoxybenzyl, while co-existing amino groups may be blocked with fluoride labile silyl carbamates.

Allyl blocking groups are useful in the presence of acid- and base-protecting groups since the former are stable and can be subsequently removed by metal or pi-acid catalysts. For example, an allyl-blocked carboxylic acid can be deprotected with a palladium(O)-catalyzed reaction in the presence of acid labile t-butyl carbamate or base-labile acetate amine protecting groups. Yet another form of protecting group is a resin to which a compound or intermediate may be attached. As long as the residue is attached to the resin, that functional group is blocked and cannot react. Once released from the resin, the functional group is available to react.

Typical blocking/protecting groups include, but are not limited to the following moieties:

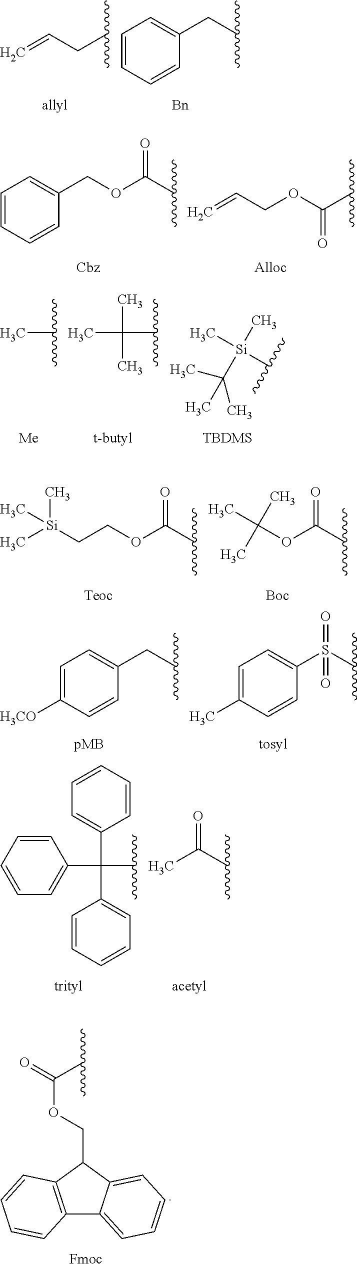

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The synthetic descriptions and specific examples that follow are only intended for the purposes of illustration, and are not to be construed as limiting in any manner to make compounds of the disclosure by other methods.

### Example 1

### SUMMARY

Four ladder-type oligo-p-phenylene containing donor-acceptor copolymers were designed, synthesized, and characterized. The ladder-type oligo-p-phenylene was used as an electron donor unit in these copolymers to provide a deeper highest occupied molecular orbital (HOMO) level for obtaining polymer solar cells with a higher open-circuit voltage, while 4,7-dithien-2-yl-2,1,3-benzothiadiazole or 5,8-dithien-2-yl-2,3-diphenylquinoxaline was chosen as an electron acceptor unit to tune the electronic band gaps of the polymers for a better light harvesting ability. The presently disclosed copolymers exhibit field-effect mobilities as high as 0.011 cm²/(Vs). Compared to fluorene-containing copolymers having the same acceptor unit, the presently disclosed ladder-type oligo-p-phenylene containing copolymers have enhanced and bathochromically shifted absorption bands and much better solubility in organic solvents. Photovoltaic applications of the presently disclosed copolymers as light-harvesting and hole-conducting materials are investigated in conjunction with [6,6]-phenyl-C₆₁-butyric acid methyl ester (PC₆₁BM) or [6,6]-phenyl-C71-butyric acid methyl ester (PC₇₁BM). Even without extensive optimization, a power conversion efficiency (PCE) of 3.7% and a high open-circuit voltage of 1.06 V are obtained under simulated solar light AM 1.5 G (100 mW/cm²) from a polymer solar cells device with an active layer containing 20 wt ladder-type tetra-p-phenylene containing copolymer (P3FTBT6) and 80 wt % C₆₁BM. Moreover, a high PCE of 4.5% was also achieved from a polymer solar cells device with an active layer containing 20 wt % P3FTBT6 and 80 wt % PC₇₁BM.

Materials.

Reagents were purchased from Aldrich, Inc., and Lancaster Synthesis Ltd. and used without further purification unless otherwise stated. 6,6′,12,12′-Tetradecyl-6,12-dihydroindeno[1,2b]fluorene, 4,7-bis(5-bromo-2-thienyl)-2,1,3-benzothiadiazole, 5,8-bis(5-bromothiophen-2-yl)-2,3-diphenylquinoxaline, and 2,8-dibromo-6,6′,12,12′-tetradecyl-6,12-dihydroindeno-[1,2b]fluorene were prepared according to the literature procedures. Setayesh, S., et al., Macromolecules 2000, 33, 2016-2020; Zheng, Q., et al. Adv. Funct. Mater. 2008, 18, 2770-2779; Hou, Q., et al., J. Mater. Chem. 2002, 12, 2887-2892; Tsami, A., et al., J. Mater. Chem. 2007, 17, 1353-1355. Column chromatography was conducted with silica gel 60 (400 mesh). 1H NMR spectra were recorded at either 300 MHz or 400 MHz. Absorption and fluorescence spectra were acquired using a spectrophotometer (Cary 50 UV/vis) and a Jobin-Yvon Fluorog FL-3.11 spectrofluorometer, respectively.

### Synthesis of 2,8-Dibromo-6,6′ 12,12′-tetradecyl-6,12-dihydroindeno-[1,2b]fluorene (6b)

To a solution of 6,6′,12,12′-tetradecyl-6,12-dihydroindeno[1,2b]fluorene (5b) (4.0 g; 4.9 mmol) in CCl₄ (100 mL) was added copper(II) bromide (5.6 g) on aluminum oxide (11.2 g). After the reaction mixture had been refluxed for 24 h, it was filtered, and the organic filtrate was washed with water and dried over magnesium sulfate. Removing the solvent afforded the crude product, which was purified by column chromatography on silica gel, eluting with petroleum ether. The title compound 6b (4.5 g, 90%) was collected as a yellow crystalline solid. ¹H NMR (300 MHz, CDCl₃, δ): 7.58 (d, J=8.4 Hz, 2H), 7.54 (s, 2H), 7.47-7.44 (m, 4H), 1.98 (t, J=8.1 Hz, 8H), 1.55-1.03 (m, 56H), 0.89-0.83 (m, 12H), 0.60 (bs, 8H); HRMS calcd for C₆₀H₉₂Br₂, 970.5566; found, 970.5552.

### Synthesis of 2,2′-(6, 6,12,12-Tetradecyl-6,12-dihydroindenol[1,2b]fluorene-2,8-diyl)bis(4,4,5,5-tetramethyl-1,3,2-dioxaborolane) (1b)

2,8-Dibromo-6,6′,12,12′-tetradecyl-6,12-dihydroindeno-[1,2b]fluorene 6b (4.5 g, 4.6 mmol), bis(pinacolato)diboron (4.6 g, 18.1 mmol), PdCl₂(dppf) (250 mg, 0.3 mmol), and KOAc (3.0 g, 30 mmol) in degassed DMF (50 mL) were stirred at 65° C. overnight. The reaction was quenched by adding water, and the resulting mixture was washed with petroleum ether (100 mL×3). The organic layers were washed with brine, dried over Na₂SO₄, and concentrated in vacuo to a white solid. The solid was purified by silica gel chromatography by 20% methylene chloride in hexane to give the desired compound as a white solid (3.75 g, 78%). ¹H NMR (400 MHz, CHCl₃, δ): 7.77 (d, J=8.4 Hz, 2H), 7.74 (d, J=5.6 Hz, 2H), 7.63 (s, 2H), 2.10-1.90 (m, 8H), 1.40 (s, 24H), 1.20-1.00 (m, 56H), 0.81 (t, J=7.2 Hz, 12H), 0.56 (bs, 8H). HRMS calcd for C₇₂H₁₁₆B₂O₄, 1066.9060; found, 1066.9078.

### Synthesis of 2,2′-(6,6,12,12-Tetrahexyl-6,12-dihydroindenol[1,2b]fluorene-2,8-diyl)bis(4,4,5,5-tetramethyl-1,3,2-dioxaborolane) (1a)

Compound 1a was prepared as a white crystalline solid according to the same procedure as that for compound 1b. Yield: 58%. ¹H NMR (400 MHz, CHCl₃, δ): 7.79 (d, J=8.4 Hz, 2H), 7.75 (d, J=5.4 Hz, 4H), 7.63 (s, 2H), 2.07-1.99 (m, 8H), 1.40 (s, 24H), 1.08-1.00 (m, 24H), 0.71 (t, J=6.6 Hz, 12H), 0.61 (bs, 8H). HRMS calcd for C₅₆H₈₄B₂O₄, 842.6556; found, 842.6559.

### Synthesis of Compound 2

Compound 2 was prepared according to the same procedure as that for compound 1b from compound 10. Zheng, Q., et al., Adv. Funct. Mater. 2008, 18, 2770-2779. Yield: 48%. ¹H NMR (400 MHz, CHCl₃, δ): 7.78 (d, J=8.4 Hz, 2H), 7.74 (d, J=4.8 Hz, 4H), 7.65 (s, 2H), 7.63 (s, 2H), 2.10-2.03 (m, 12H), 1.41 (s, 24H), 1.03 (bs, 40H), 0.72-0.66 (m, 30H). HRMS calcd for C₇₅H₁₁₂B2O₄, 1098.8747; found, 1098.8769.

### Synthesis of PIFDTQ10

2,2′-(6,6,12,12-Tetradecyl-6,12-dihydroindeno[1,2b]fluorene-2,8-diyl)bis(4,4,5,5-tetramethyl-1,3,2-dioxaborolane) (0.56 g, 0.53 mmol), 5,8-bis(5-bromo-2-thienyl)-2,3-diphenylquinoxaline (0.317 g, 0.53 mmol), and 20 mL of K₂CO₃ solution (2 M in H₂O) were added into a three-neck flask containing 50 mL of toluene. The flask was connected to a reflux condenser and filled with nitrogen. After bubbling the toluene solution for 30 min, 50 mg of Pd(PPh₃)₄ (ca. 5 mol %) were added. The degassed reaction mixture was stirred under nitrogen at 95° C. for 2 days. Workup of the reaction mixture and isolation of the polymer occurred by extraction with chloroform; washing of the combined organic extracts with 1 M HCl, a sat. aqueous NaHCO₃ solution, and water; and drying over MgSO₄. Then, this organic extract was filtered through a short florisil column. After partial evaporation of the solvent, the concentrated solution was precipitated into methanol, and the solid was collected by filtration and extracted in a Soxhlet setup with methanol for 24 h and then with hexane for another 24 h. The insoluble remainders were redissolved in chloroform and precipitated into methanol. After filtration and drying in vacuo at 50° C. overnight, 0.30 g of the polymers was obtained (45% yield). ¹H NMR (400 MHz, CDCl₃, δ): 8.24 (s, 2H), 7.96-7.47 (m, 22H), 2.11 (bs, 8H), 1.20-1.00 (m, 56H), 0.84-0.77 (m, 20H). GPC: Mₙ=7.8 kg/mol, M_{w}=21 kg/mol, PDI=2.65.

### Synthesis of PIFTBT10

PIFTBT10 was prepared according to the same procedure as that for PIFDTQ10.71% yield, ¹H NMR (300 MHz, CDCl₃, δ): 8.18 (s, 2H), 7.97 (s, 2H), 7.79-7.53 (m, 10H), 2.10 (bs, 8H), 1.21-1.00 (m, 56H), 0.83-0.73 (m, 20H). GPC=26.3 kg/mol, M_{w}=63.5 kg/mol, PDI=2.42.

### Synthesis of PIFTBT6

PIFTBT6 was prepared according to the same procedure as that for PIFDTQ10. 31% yield, 1H NMR (300 MHz, CDCl3, δ): 8.18 (s, 2H), 7.98 (s, 2H), 7.80-7.54 (m, 10H), 2.11 (bs, 8H), 1.17 (bs, 24H), 0.77-0.68 (m, 20H). GPC=22.5 kg/mol, M_{w}=45.9 kg/mol, PDI=2.03.

### Synthesis of P3FTBT6

P3FTBT6 was prepared according to the same procedure as that for PIFDTQ10; 43% yield; 1H NMR (300 MHz, CDCl3, δ): 8.19 (s, 2H), 7.98 (s, 2H), 7.80-7.53 (m, 12H), 2.11 (bs, 12H), 1.10 (bs, 36H), 0.75-0.70 (m, 30H). GPC Mₙ=14.2 kg/mol, M_{w}=24.9 kg/mol, PDI=1.75.

Computational Methods.

All of the DFT calculations were performed with the Gaussian 03 program package (Gaussian, Inc.). The structures shown in FIG. 10 were fully optimized without any symmetry restrictions at the B3LYP level. A split-valence plus polarization basis set, 6-31G(d), was used. The DFT/B3LYP/6-31G(d)-optimized structures for the model compounds were used for electronic-structure analysis. HOMO and LUMO isosurfaces shown in FIG. 10 were plotted using the Gabedit software (http://gabedit.sourceforge.net).

Field-Effect Transistors.

Top contact FETs of copolymers were fabricated on hexamethyldisilazane (HMDS)-treated or untreated SiO₂/Si substrates. The semiconducting films were deposited by spin-casting pure polymers (approximately 7 mg/mL in chlorobenzene) at 1500 rpm on the substrates. Gold top contact source and drain electrodes of approximately 50-nm thickness were vapor deposited through a shadow mask. The channel widths and lengths were about 6.5 mm and about 270 μm, respectively. Devices were measured in air using an Agilent 4155C semiconductor parameter analyzer with the ICS lite software.

Solar Cell Fabrication.

Indium tin oxide (ITO)-covered glass substrates were cleaned by ultrasonification sequentially in detergent, water, acetone, and isopropyl alcohol for 30 min each and then dried in an oven at 90° C. overnight. A thin layer (approximately 40 nm) of poly(3,4-ethylenedioxythiophene)/poly(styrene sulfonic acid) PEDOT/PSS (Baytron P Al 4083) was spin-coated onto the ITO surface, which was pretreated by oxygen plasma for 5 min. The substrates were baked at 120° C. for 2 h. An active layer (about 150 nm to about 4180 nm) was fabricated in the ambient by spin-casting (800 rpm) a blend of polymer: PC₆₁BM/polymer:PC₇₁BM (purchased from Nano C) in a 1:3 (or 1:3.5) w/w ratio on the ITO/PEDOT:PSS substrates without further special treatment. For optimization of P3FTBT6, an active layer of (about 100 nm to about 4110 nm) was fabricated in the ambient by spin-casting (1500 rpm) a blend of P3FTBT6:PC₆₁BM or P3FTBT6:PC₇₁BM in a 1:4 w/w ratio on the ITO/PEDOT:PSS substrates. The devices were kept at room temperature for 24 h. Then, the cathode, a bilayer of a thin (1.0 nm) Cs₂CO₃ layer covered with 100 nm Al, was thermally evaporated. The thermal evaporation of Cs₂CO₃ and Al was done under a shadow mask. The active area of the devices was fixed at 0.07 cm². As shown in the inset of FIG. 13, an island-type cathode design was chosen to exclude any excess photocurrent generated from the parasitic solar cell structure, where the conductive PEDOT layer can act as an effective anode. Kim, M.-S., et al., Appl. Phys. Lett. 2008, 92, 133301/1-133301/3. Four polymers and PC₆₁BM (or PC₇₁BM) were dissolved together in a mixture of chorobenzene and o-dichlorobenzene (4:1, v/v) to give an overall 20 mg/mL solution. PIFDTQ10 and PC₇₁BM were dissolved together in a mixture of chorobenzene and o-dichlorobenzene (4:1, v/v) to give an overall 28 mg/mL solution.

Device Characterization.

Device characterization in ambient environment was performed under AM 1.5 G irradiation (100 mW/cm²) on an Oriel Xenon solar simulator. The solar cell devices were illuminated through their ITO sides. The current density-voltage curves were measured in air by an Agilent 4155C semiconductor parameter analyzer with the ICS lite software. Since there are some deviations in the spectral output of the solar simulator with respect to the standard AM1.5 spectrum, the J_{sc} values for the solar cell devices were corrected by introducing a mismatch factor as shown in eq. 5:

J_{sc}=J_{sc}(measured)×m (eq. 5)

where m is the spectral mismatch factor calibrated using an NREL calibrated PV-measurement mono-Si solar cell. A mismatch factor of 0.87 was used for all short circuit currents and power conversion efficiencies. External quantum efficiencies (EQEs) ware calculated from the photocurrents under short-circuit conditions. The solar cell device was illuminated through its ITO side with a 100 W Xe lamp (PhotoMax) coupled to a ¼ m monochromator (Oriel Cornerstone). Incident irradiances were measured using an optometer (Graesby Optronics 5370 with a United Detector Technology silicon detector), and photocurrents were measured using an electrometer (Keithley 617).

Atomic Force Microscopy.

AFM was performed in tapping mode using a Digital Instruments microscope (Molecular Imaging PicoPlus). Films for AFM were prepared on PEDOT:PSS-coated ITO substrates prepared in identical fashion to those prepared for device fabrication. The average roughnesses of films were calculated from AFM topography images of scanned areas using the Gwyddion analysis tool (downloadable from http://gwyddion.net).

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.
Coakley, K. M.; McGehee, M. D. Chem. Mater. 2004, 16, 4533-4542.
Chen, L. M.; Hong, Z. R.; Li, G.; Yang, Y. Adv. Mater. 2009, 21, 1434-1449.
Gunes, S.; Neugebauer, H.; Sariciftci, N. S. Chem. Rev. 2006, 107, 1324-1338.
Sariciftci, N. S.; Smilowitz, L.; Heeger, A. J.; Wudl, F. Science 1992, 258, 1474-1476.
Campoy-Quiles, M.; Ferenczi, T.; Agostinelli, T.; Etchegoin, P. G.; Kim, Y.; Anthopoulos, T. D.; Stavrinou, P. N.; Bradley, D. D. C.; Nelson, J. Nat. Mater. 2008, 7, 158-164.
Li, G.; Yao, Y.; Yang, H.; Shrotriya, V.; Yang, G.; Yang, Y. Adv. Funct. Mater. 2007, 17, 1636-1644.
Li, G.; Shrotriya, V.; Huang, J.; Yao, Y.; Moriarty, T.; Emery, K.; Yang, Y. Nat. Mater. 2005, 4, 864-868.
Wang, W.; Wu, H.; Yang, C.; Luo, C.; Zhang, Y.; Chen, J.; Cao, Y. Appl. Phys. Lett. 2007, 90 (18), 183512/1-183512/3.
Ma, W.; Yang, C.; Gong, X.; Lee, K.; Heeger, A. J. Adv. Funct. Mater. 2005, 15, 1617-1622.
Woo, C. H.; Thompson, B. C.; Kim, B. J.; Toney, M. F.; Frechet, J. M. J. J. Am. Chem. Soc. 2008, 130, 16324-16329.
Hou, J.; Chen, H.-Y.; Zhang, S.; Li, G.; Yang, Y. J. Am. Chem. Soc. 2008, 130, 16144-16145.
Liang, Y. Y.; Wu, Y.; Feng, D. Q.; Tsai, S. T.; Son, H. J.; Li, G.; Yu, L. P. J. Am. Chem. Soc. 2009, 131, 56-57.
Baek, N. S.; Hau, S. K.; Yip, H. L.; Acton, O.; Chen, K. S.; Jen, A. K. Y. Chem. Mater. 2008, 20, 5734-5736.
Chen, C.-P.; Chan, S.-H.; Chao, T.-C.; Ting, C.; Ko, B.-T. J. Am. Chem. Soc. 2008, 130, 12828-12833.
Lee, J. K.; Ma, W. L.; Brabec, C. J.; Yuen, J.; Moon, J. S.; Kim, J. Y.; Lee, K.; Bazan, G. C.; Heeger, A. J. J. Am. Chem. Soc. 2008, 130, 3619-3623.
Lee, J.-Y.; Shin, W.-S.; Haw, J.-R.; Moon, D.-K. J. Mater. Chem. 2009, 19, 4938-4945.
Moule, A. J.; Tsami, A.; Bunnagel, T. W.; Forster, M.; Kronenberg, N. M.; Scharber, M.; Koppe, M.; Morana, M.; Brabec, C. J.; Meerholz, K.; Scherf, U. Chem. Mater. 2008, 20, 4045-4050.
Muhlbacher, D.; Scharber, M.; Morana, M.; Zhu, Z. G.; Waller, D.; Gaudiana, R.; Brabec, C. Adv. Mater. 2006, 18, 2884-2889.
Zhang, F. L.; Mammo, W.; Andersson, L. M.; Admassie, S.; Andersson, M. R.; Inganas, L.; Admassie, S.; Andersson, M. R.; Ingands, O. Adv. Mater. 2006, 18, 2169-2173.
Zhang, F. L.; Perzon, E.; Wang, X. J.; Mammo, W.; Andersson, M. R.; Inganas, O. Adv. Funct Mater. 2005, 15, 745-750.
Mondal, R.; Miyaki, N.; Becerril, H. A.; Norton, J. E.; Parmer, J.; Mayer, A. C.; Tang, M. L.; Bredas, J.-L.; McGehee, M. D.; Bao, Z. Chem. Mater. 2009, 21, 3618-3628.
Svensson, M.; Zhang, F. L.; Veenstra, S. C.; Verhees, W. J. H.; Hummelen, J. C.; Kroon, J. M.; Inganas, O.; Andersson, M. R. Adv. Mater. 2003, 15, 988-991.
Zhou, Q.; Hou, Q.; Zheng, L.; Deng, X.; Yu, G.; Cao, Y. Appl. Phys. Lett. 2004, 84, 1653-1655.
Zhang, F. L.; Jespersen, K. G.; Bjorstrom, C.; Svensson, M.; Andersson, M. R.; Sundstrom, V.; Magnusson, K.; Moons, E.; Yartsev, A.; Inganas, O. Adv. Funct. Mater. 2006, 16, 667-674.
Gadisa, A.; Zhang, F. L.; Sharma, D.; Svensson, M.; Andersson, M. R.; Inganas, O. Thin Solid Films 2007, 515, 3126-3131.
Gedefaw, D.; Zhou, Y.; Hellstroem, S.; Lindgren, L.; Andersson, L. M.; Zhang, F.; Mammo, W.; Inganaes, O.; Andersson, M. R. J. Mater. Chem. 2009, 19, 5359-5363.
Slooff, L. H.; Veenstra, S. C.; Kroon, J. M.; Moet, D. J. D.; Sweelssen, J.; Koetse, M. M. Appl. Phys. Lett. 2007, 90, 143506/1-143506/3.
Veldman, D.; Ipek, O.; Meskers, S. C. J; Sweelssen, J.; Koetse, M. M.; Veenstra, S. C.; Kroon, J. M.; Bavel, S. S. v.; Loos, J.; Janssen, R. A. J. J. Am. Chem. Soc. 2008, 130, 7721-7735.
Blouin, N.; Michaud, A.; Gendron, D.; Wakim, S.; Blair, E.; Neagu-Plesu, R.; Belletete, M.; Durocher, G.; Tao, Y.; Leclerc, M. J. Am. Chem. Soc. 2007, 130, 732-742.
Blouin, N.; Michaud, A.; Leclerc, M. Adv. Mater. 2007, 19, 2295-2300.
Wen, S.; Pei, J.; Zhou, Y.; Li, P.; Xue, L.; Li, Y.; Xu, B.; Tian, W. Macromolecules 2009, 42 (14), 4977-4984.
Park, S. H.; Roy, A.; Beaupre, S.; Cho, S.; Coates, N.; Moon, J. S.; Moses, D.; Leclerc, M.; Lee, K.; Heeger, A. J. Nat. Photonics 2009, 3, 297-302.

Lindgren, L. J.; Zhang, F.; Andersson, M.; Barrau, S.; Hellstroem, S.; Mammo, W.; Perzon, E.; Inganaes, O.; Andersson, M. R. Chem. Mater. 2009, 21, 3491-3502.
Kitazawa, D.; Watanabe, N.; Yamamoto, S.; Tsukamoto, J. Appl. Phys. Lett. 2009, 95 (5), 053701/1-053701/3.
Setayesh, S.; Marsitzky, D.; Mullen, K. Macromolecules 2000, 33, 2016-2020.
Sonar, P.; Zhang, J.; Grimsdale, A. C.; Mullen, K.; Surin, M.; Lazzaroni, R.; Leclere, P.; Tierney, S.; Heeney, M.; McCulloch, I. Macromolecules 2004, 37, 709-715.
Zheng, Q.; Gupta, S. K.; He, G. S.; Tan, L.-S.; Prasad, P. N. Adv. Funct. Mater. 2008, 18, 2770-2779.
Usta, H.; Risko, C.; Wang, Z.; Huang, H.; Deliomeroglu, M. K.; Zhukhovitskiy, A.; Facchetti, A.; Marks, T. J. J. Am. Chem. Soc. 2009, 131, 5586-5608.
Zhang, W.; Smith, J.; Hamilton, R.; Heeney, M.; Kirkpatrick, J.; Song, K.; Watkins, S. E.; Anthopoulos, T.; McCulloch, I. J. Am. Chem. Soc. 2009, 131, 10814-10815.
Yen, W.-C.; Pal, B.; Yang, J.-S.; Hung, Y.-C.; Lin, S.-T.; Chao, C.-Y.; Su, W.-F. J. Polym. Sci., Part A: Polym. Chem. 2009, 47, 5044-5056.
Nguyen, L. H.; Hoppe, H.; Erb, T.; Guenes, S.; Gobsch, G.; Sariciftci, N. S. Adv. Funct. Mater. 2007, 17, 1071-1078.
Hou, Q.; Xu, Y.; Yang, W.; Yuan, M.; Peng, J.; Cao, Y. J. Mater. Chem. 2002, 12, 2887-2892.
Tsami, A.; Bunnagel, T. W.; Farrell, T.; Scharber, M.; Choulis, S. A.; Brabec, C. J.; Scherf, U. J. Mater. Chem. 2007, 17, 1353-1355.
Pommerehne, J.; Vestweber, H.; Guss, W.; Mahrt, R. F.; Bassler, H.; Porsch, M.; Daub, J. Adv. Mater. 1995, 7, 551-554.
Scharber, M. C.; Wuhlbacher, D.; Koppe, M.; Denk, P.; Waldauf, C.; Heeger, A. J.; Brabec, C. L. Adv. Mater. 2006, 18, 789-794.
Mihailetchi, V. D.; van Duren, J. K. J.; Blom, P. W. M.; Hummelen, J. C.; Janssen, R. A. J.; Kroon, J. M.; Rispens, M. T.; Verhees, W. J. H.; Wienk, M. M. Adv. Funct. Mater. 2003, 13, 43-46.
Chen, M.-H.; Hou, J.; Hong, Z.; Yang, G.; Sista, S.; Chen, L.-M.; Yang, Y. Adv. Mater. 2009, 21, 4238-4242.
Wienk, M. M.; Kroon, J. M.; Verhees, W. J. H.; Knol, J.; Hummelen, J. C.; van Hal, P. A.; Janssen, R. A. J. Angew. Chem., Int. Ed. 2003, 42, 3371-3375.
Kim, M.-S.; Kang, M.-G.; Guo, L. J.; Kim, J. Appl. Phys. Lett. 2008, 92, 133301/1-133301/3.
Tang, C. W.; VanSlyke, S. A.; Appl. Phys. Lett. 1987, 51, 913.
Tang, C. W. Appl. Phys. Lett. 1986, 48, 183.
Bao, Z.; Lovinger, A. J.; Dodabalapur, A. Appl. Phys. Lett. 1996, 69, 3066.
Ma, L. P.; Liu, J.; Yang, Y. Appl. Phys. Lett. 2002, 80, 2997).
Brabec, et al., Adv. Func. Mater. 2001, 11, 374-380.
Sariciftci, N. S., Curr. Opinion in Solid State and Materials Science, 1999, 4, 373-378.
Sariciftci, N., Materials Today 2004, 36.
Hoppe, H. et al., J. Mater. Res. 2004, 19, 1924.
Nakamura, et al., Applied Physics Letters 2005, 87, 132105.
Paddinger et al., Advanced Functional Materials 2003, 13, No. 1, January, 85.
Kim, et al., Photovoltaic Materials and Phenomena Scell 2004, 1371.
Dennler, G., et al., J. Mater. Res., 2005, 20, No. 12, 3224.
Inoue, et al., Mater. Res. Soc. Symp. Proc., 836, L.3.2.1.
Li et al., J. Applied Physics 2005, 98, 043704.
U.S. Patent Publication No. US2006/0174937 to Zhou, for High Performance Organic Materials for Solar Cells, published Aug. 10, 2006.
U.S. Patent Publication No. US2006/0225782 to Berke et al., for Photovoltaic Cells Having a Thermoelectric Material, published Oct. 12, 2006.
U.S. Patent Publication No. US2008/0163927 to Sohn et al., for Polymer Solar Cell and Method of Manufacturing the Same, published Jul. 10, 2008.
U.S. Patent Publication No. US2008/0299293 to Sheina et al., for Solvent System for Conjugated Polymers, published Dec. 4, 2008.
U.S. Patent Publication No. US2008/0315751 to Sheina et al, for Aryl-Substituted Conjugated Polymers, published Dec. 25, 2008.
U.S. Patent Publication No. 2010/0078074 to Yang et al., for Active Materials for Photoelectric Devices and Devices That Use the Materials, published Apr. 1, 2010.

Although the foregoing subject matter has been described in some detail by way of illustration and example for purposes of clarity of understanding, it will be understood by those skilled in the art that certain changes and modifications can be practiced within the scope of the appended claims.

1. A compound of Formula (I): 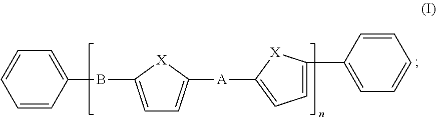
wherein: n is an integer from 1 to 1,000;
X is selected from the group consisting of S, O, and NR₆, wherein R₆ is selected from the group consisting of hydrogen and C₁-C₄ unsubstituted or substituted, linear or branched alkyl;
A comprises an electron-accepting fused ring system; and
B comprises a linearly overlapping fluorene system comprising
from 2 to 9 fluorene groups.

2. The compound of claim 1, wherein the linearly overlapping fluorene system comprises a divalent radical having a chemical structure selected from the group consisting of: 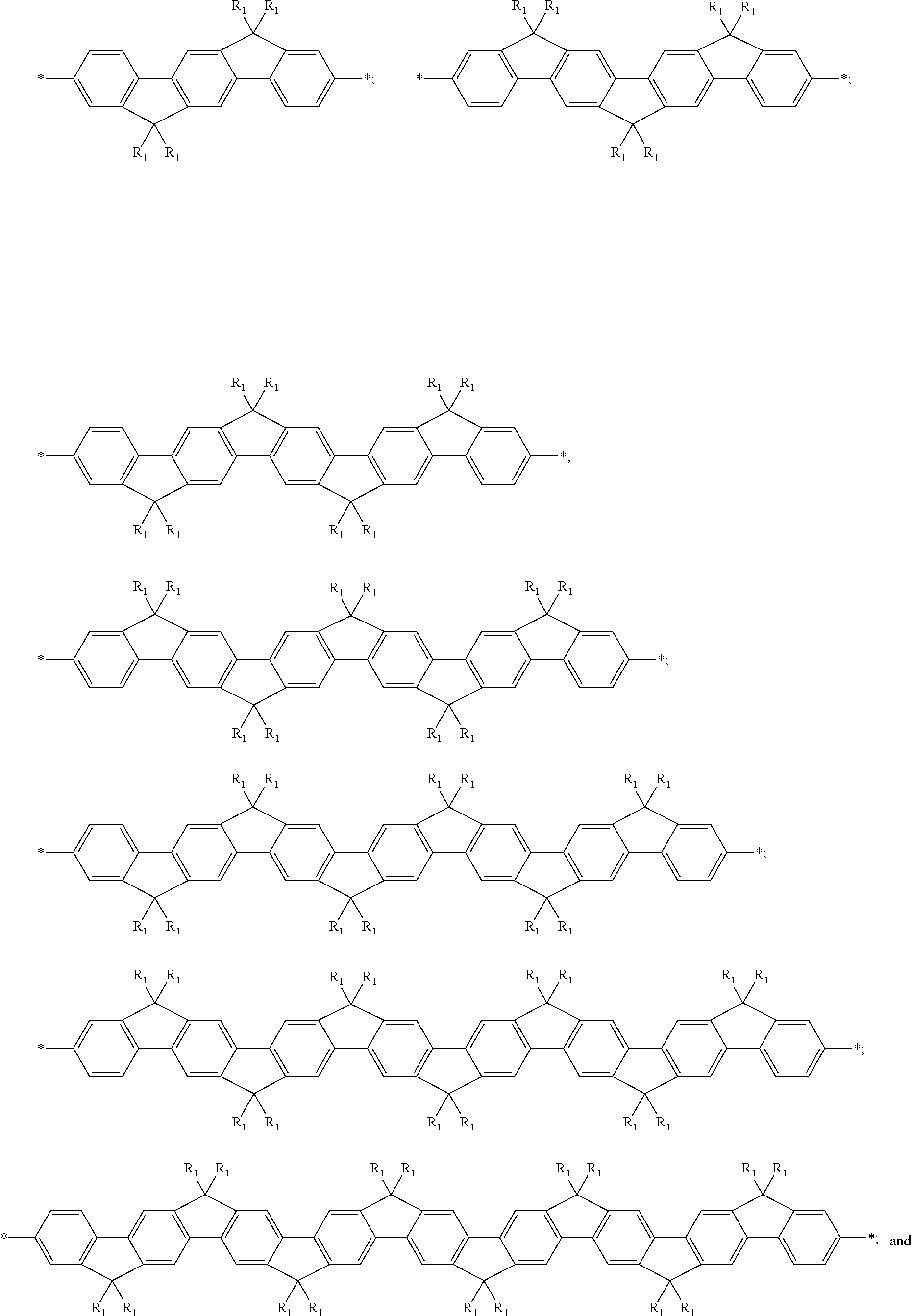 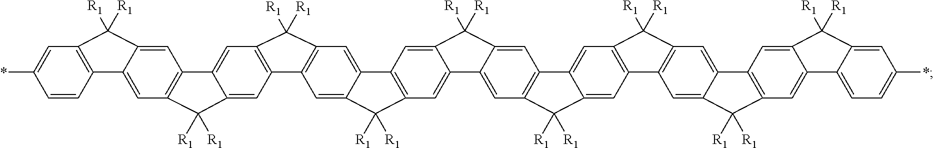
wherein:
each R₁ independently comprises a linear or branched, substituted or unsubstituted C₄-C₃₀ alkyl chain, wherein one or more oxygen, sulfur, or nitrogen atoms can be substituted for a carbon atom in the alkyl chain; and
* indicates the points of attachment of the divalent linearly overlapping fluorene system to the compound of Formula (I).

3. The compound of claim 1, wherein the electron-accepting fused ring system comprises a divalent fused-ring heterocyclic moiety selected from the group consisting of a substituted or unsubstituted benzothiadiazole, a substituted or unsubstituted quinoxaline, a substituted or unsubstituted benzobisthiazole, and a substituted or unsubstituted naphthothiadiazole.

4. The compound of claim 3, wherein the electron-accepting fused ring system comprises a divalent radical comprising a fused ring structure selected from the group consisting of a substituted or unsubstituted 2,1,3-benzothiadiazole; a substituted or unsubstituted 2,3-diphenylquinoxaline; a substituted or unsubstituted benzo[1,2-c; 4,5-c′]bis[1,2,5]thiadiazole; and a substituted or unsubstituted naphtho[2,3-c][1,2,5]thiadiazole.

5. The compound of claim 4, wherein the electron-accepting fused ring system comprises a divalent radical comprising a fused ring structure selected from the group consisting of 2,1,3-benzothiadiazole and 2,3-diphenylquinoxaline.

6. The compound of claim 1, wherein the compound of Formula (I) has a chemical structure selected from the group consisting of: 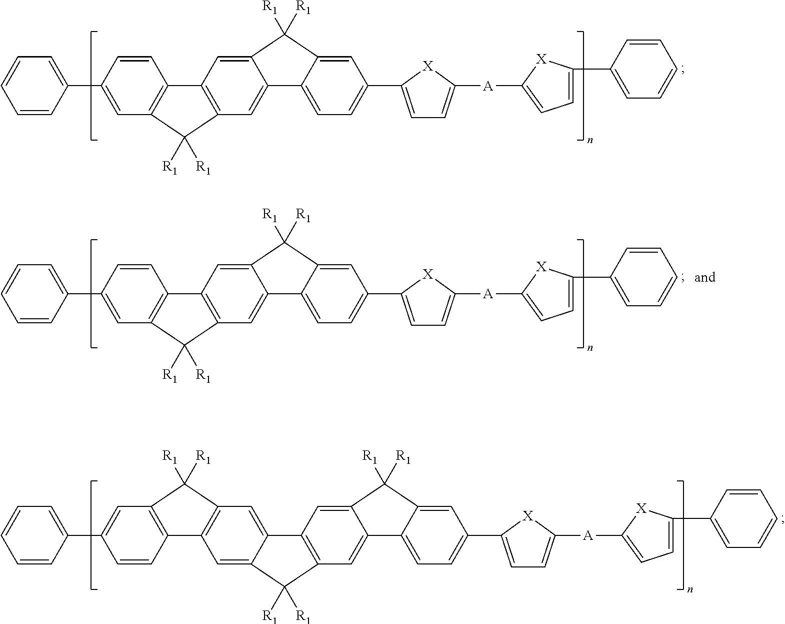
wherein: n is an integer from 1 to 1000;
X is selected from the group consisting of S, O, and NR₆, wherein R₆ is selected from the group consisting of hydrogen and C₁-C₄ unsubstituted or substituted, linear or branched alkyl;
A comprises an electron-accepting fused ring system; and
each R₁ independently comprises a linear or branched, substituted or unsubstituted C₄-C₃₀ alkyl chain, wherein one or more oxygen, sulfur, or nitrogen atoms can be substituted for a carbon atom in the alkyl chain.

7. The compound of claim 1, wherein the compound of Formula (I) has a chemical structure selected from the group consisting of: 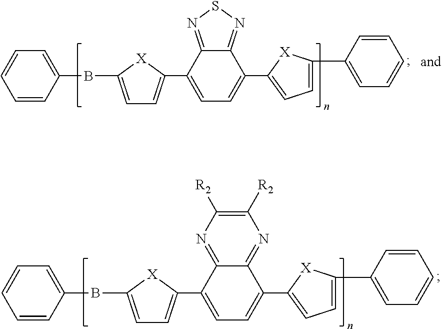
wherein: n is an integer from 1 to 1,000;
X is selected from the group consisting of S, O, and NR₆, wherein R₆ is selected from the group consisting of hydrogen and C₁-C₄ unsubstituted or substituted, linear or branched alkyl;
B comprises a linearly overlapping fluorene system comprising from 2 to 9 fluorene groups; and
each R₂ is independently selected from the group consisting of hydrogen, hydroxyl, amino, alkoxyl, halogen, substituted or unsubstituted alkyl, substituted or unsubstituted heteroalkyl, perfluoroalkyl, substituted or unsubstituted cycloalkyl, substituted or unsubstituted heterocycloalkyl, substituted or unsubstituted aryl, substituted or unsubstituted arylalkyl, substituted or unsubstituted heteroaryl, and substituted or unsubstituted heteroarylalkyl.

8. The compound of claim 1, wherein the compound of Formula (I) has a chemical structure selected from the group consisting of: 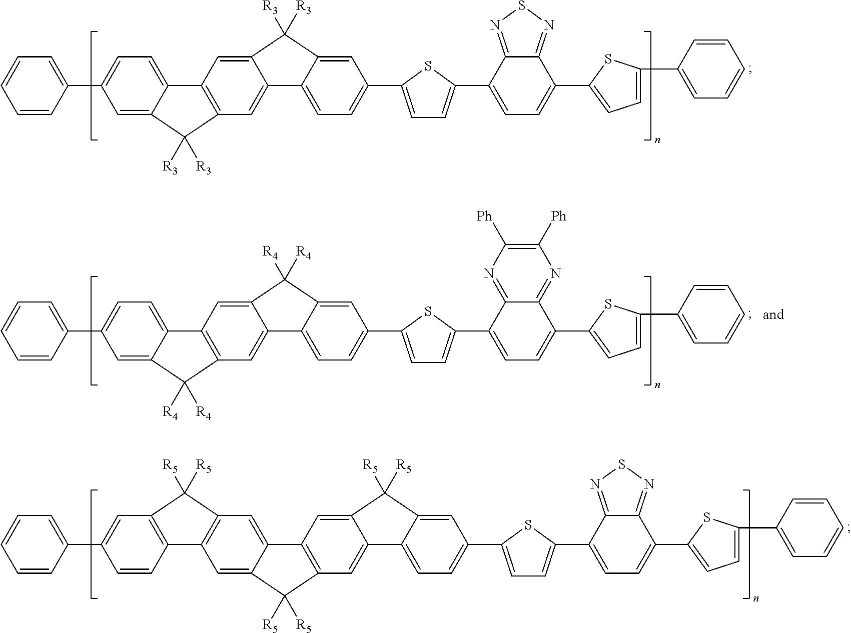
wherein: n is an integer from 1 to 1000;
Ph is phenyl;
R₃ is selected from the group consisting of n-C₆H₁₃ and n-C₁₀H₂₁;
R₄ is n-C₁₀H₂₁; and
R₅ is n-C₆H₁₃.

9. An electronic or electro-optic device comprising
an electroactive material comprising a compound of Formula (I): 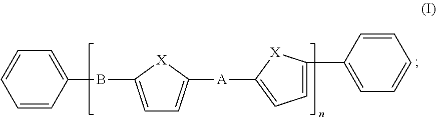
wherein: n is an integer from 1 to 1,000;
X is selected from the group consisting of S, O, and NR₆, wherein R₆ is selected from the group consisting of hydrogen and C₁-C₄ unsubstituted or substituted, linear or branched alkyl;
A comprises an electron-accepting fused ring system; and
B comprises a linearly overlapping fluorene system comprising from 2 to 9 fluorene groups.

10. The electronic or electro-optic device of claim 9, wherein the device is selected from the group consisting of a field-effect transistor (FET), a solar cell, a diode, and a chemical sensor.

11.-20. (canceled)

21. A The chemical sensor of claim 10, wherein the electroactive property of the electroactive material is changed when in contact with a second chemical compound.

22.-25. (canceled)

26. The chemical sensor of claim 21, wherein the second chemical compound comprises an amino group.

27. An electroactive material comprising a compound of Formula (I): 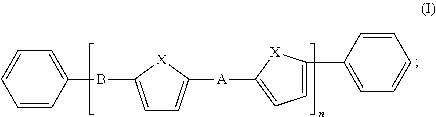
wherein: n is an integer from 1 to 1,000;
X is selected from the group consisting of S, O, and NR₆, wherein R₆ is selected from the group consisting of hydrogen and C₁-C₄ unsubstituted or substituted, linear or branched alkyl;
A comprises an electron-accepting fused ring system;
B comprises a linearly overlapping fluorene system comprising from 2 to 9 fluorene groups; and
a second, electron-accepting group.

28. The electroactive material of claim 27, wherein the electron-accepting group selected from a group consisting of a C₆₀ fullerene, a C₇₀ fullerene, and a C₈₀ or higher fullerene.

29. The electroactive material of claim 27, wherein the electron-accepting group is in the form of a polymer.

30. The electroactive material of claim 28, wherein the electron-accepting group is covalently attached to a polymer.

31. An electronic or electro-optic device comprising the electroactive material of claim 27.

32. The electronic or electro-optic device of claim 31, wherein the device is selected from the group consisting of a field-effect transistor (FET), a solar cell, a diode, and a chemical sensor.

33. The chemical sensor of claim 32, wherein the electroactive property of the electroactive material is changed when in contact with a second chemical compound.

34. The chemical sensor of claim 33, wherein the second chemical compound comprises an amino group.

35. The solar cell of claim 32, wherein the electroactive material comprises a fullerene bulk heterojunction.
